(19) United States
(12) Patent Application Publication
(10) Pub. No.: US 2009/0239625 A1
(43) Pub. Date: Sep. 24, 2009

(54) GAMING MACHINE WHICH DISPLAYS A START TIMING OF A SPECIAL GAME AND PLAYING METHOD THEREOF

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/239,498

(22) Filed: Sep. 26, 2008

Related U.S. Application Data
(60) Provisional application No. 61/037,507, filed on Mar. 18, 2008.

(51) Int. Cl. A63F 13/00; A63F 9/24

(52) U.S. Cl. 463/20; 463/16

(57) ABSTRACT

The gaming machine 1 includes: a base game offering a chance of winning a payout according to a predetermined combination; a chance game offering a chance of obtaining a JP chance which qualifies a player to join a JP game offering a chance of winning a higher payout than the base game; a display displaying information which is based on a timing to run the JP game; a memory which stores the number of JP chances; and a controller 100 which is programmed to operate as below. The controller 100 displays information which is based on a timing to run a JP game, runs a base game and a chance game at the same time, determines and awards a payout according to a result of the base game, determines the number of JP chances according to a result of the chance game and awards them, accumulatively stores in the memory the number of awarded JP chances, and awards a payout determined according to a result of a JP game which is run at a predetermined timing.

### CROSS REFERENCE TO RELATED APPLICATION

The present application claims priority from Provisional Patent Application No. 61/037,507, which was filed on Mar. 18, 2008, the disclosure of which is herein incorporated by reference in its entirety.

### BACKGROUND OF THE INVENTION

1. Field of the Invention

The present invention relates to a gaming machine and a playing method thereof.

2. Description of Related Art

Among existing gaming machines, there is a gaming machine including: two or more gaming terminals; terminal controllers respectively provided to the gaming terminal, each of which controllers causes associated one of the gaming terminals to run a game; a center controller for controlling all the terminal controllers. This type of gaming machine is disclosed in specifications of U.S. Pat. No. 5,820,459, No. 4,283,709, or No. 6,003,013. A terminal controller of a gaming terminal runs a game and awards a payout based on the result of the game independently from another terminal controller of another gaming terminal. The center controller provides various jackpots such as progressive jackpots, mystery jackpots, or the like.

An object of the invention is to provide a gaming machine providing an entertainment characteristic which is not brought about by the above mentioned prior art, and a playing method thereof.

It is another object of the present invention to provide a gaming machine and a playing method thereof, each realizing a new gaming characteristic by qualifying a player to join a special game through a chance game run at the same time a base game is run.

### SUMMARY OF THE INVENTION

A gaming machine of the present invention is a gaming device including: a base game offering a chance of winning a payout according to a predetermined combination; a chance game offering a chance of obtaining a chance flag which qualifies a player to join a bonus game offering a chance of winning a higher payout than the base game; a display displaying information which is based on a timing to run the bonus game; a storage unit storing the number of chance flags; and a controller which is programmed to perform the steps of: (a1) displaying on the display the information based on the timing to run the bonus game; (a2) running the base game and the chance game at the same time; (a3) determining and awarding a payout according to a result of the base game; (a4) determining the number of chance flags according to a result of the chance game, and awarding a resulting number of chance flags; (a5) accumulatively storing in the storage unit the number of chance flags awarded; and (a6) awarding a payout determined according to a result of the bonus game which is run when the number of the chance flags stored in the storage unit equals or surpasses a predetermined number.

According to this structure, information based on a timing to run the bonus game is displayed on the display. Concurrently run are a base game offering a chance of winning a payout according to a predetermined combination and a chance game offering a chance of obtaining a chance flag which qualifies a player to join a bonus game offering a chance of winning a higher payout than the base game. A payout is determined according to a result of the base game and awarded. The number of chance flags is determined according to a result of the chance game, and a resulting number of chance flags are awarded. In the storage unit the number of chance flags awarded is accumulatively stored. A payout determined according to a result of the bonus game which is run when the number of the chance flags stored in the terminal storage unit equals or surpasses a predetermined number is awarded.

As a result of this above, a player is allowed to play a base game and a chance game at the same time while information based on a timing at which a bonus game is run is displayed on the display, and to obtain not only a result of the base game but also a chance flag. Consequently a player is allowed to concentrate on getting chance flags until the timing of the next bonus game, and this realizes a new entertainment characteristic such that a chance game is playable while a base game is being played.

The gaming machine of the present invention is adapted so that the controller randomly determines the timing to run the bonus game.

According to this structure, a timing to run a bonus game is randomly determined. This provides a player with a game with further improved entertainment characteristic.

A gaming machine of the present invention, comprises: a base game offering a chance of winning a payout according to a predetermined combination; a chance game offering a chance of obtaining a chance flag which qualifies a player to join a special game offering a chance of winning a higher payout than the base game; a display displaying information which is based on a timing to run the bonus game; a storage unit storing the number of chance flags; and a controller which is programmed to perform the steps of: (b1) displaying on the display the number of the base game before the timing to run the bonus game; (b2) running the base game and the chance game at the same time; (b3) determining and awarding a payout according to a result of the base game; (b4) determining the number of chance flags according to a result of the chance game, and awarding a resulting number of chance flags; (b5) accumulatively storing in the storage unit the number of chance flags awarded; and (b6) awarding a payout determined according to a result of the bonus game which is run when the number of the chance flags stored in the storage unit equals or surpasses a predetermined number.

According to the structure above, the number of playable base games until the timing to run a bonus game is displayed on the display. Concurrently run are a base game offering a chance of winning a payout according to a predetermined combination and a chance game offering a chance of obtaining a chance flag which qualifies a player to join a bonus game offering a chance of winning a higher payout than the base game. A payout is determined according to a result of the base game and awarded. The number of chance flags is determined according to a result of the chance game, and a resulting number of chance flags are awarded. In the storage unit the number of chance flags awarded is accumulatively stored. A payout determined according to a result of the bonus game which is run when the number of the chance flags stored in the terminal storage unit equals or surpasses a predetermined number is awarded.

As a result of this above, a player is allowed to play a base game and a chance game at the same time while the number of playable base games until the timing to run a bonus game is displayed on the display, and to obtain not only a result of the base game but also a chance flag. Consequently a player is allowed to concentrate on getting chance flags while he/she plays a limited number of base games before the next bonus game, and this realizes a new entertainment characteristic such that a chance game is playable while a base game is being played.

A gaming machine of the present invention, comprises: a base game offering a chance of winning a payout according to a predetermined combination; a chance game offering a chance of obtaining a chance flag which qualifies a player to join a bonus game offering a chance of winning a higher payout than the base game; a display displaying information which is based on a timing to run the bonus game; a storage unit storing the number of chance flags; and a controller which is programmed to perform the steps of: (c1) on the display, counting down time left until the timing to run the bonus game; (c2) running the base game and the chance game at the same time; (c3) determining and awarding a payout according to a result of the base game; (c4) determining the number of chance flags according to a result of the chance game, and awarding a resulting number of chance flags; (c5) accumulatively storing in the storage unit the number of chance flags awarded; and (c6) awarding a payout determined according to a result of the bonus game which is run when the number of the chance flags stored in the storage unit equals or surpasses a predetermined number.

According to the structure above, time left until the timing to run a bonus game is counted down on the display. Concurrently run are a base game offering a chance of winning a payout according to a predetermined combination and a chance game offering a chance of obtaining a chance flag which qualifies a player to join a bonus game offering a chance of winning a higher payout than the base game. A payout is determined according to a result of the base game and awarded. The number of chance flags is determined according to a result of the chance game, and a resulting number of chance flags are awarded. In the storage unit the number of chance flags awarded is accumulatively stored. A payout determined according to a result of the bonus game which is run when the number of the chance flags stored in the terminal storage unit equals or surpasses a predetermined number is awarded.

As a result of the above, a player is allowed to play a base game and a chance game at the same time while time left until a bonus game is run is counted down on the display, and to obtain not only a result of a base game but also a chance flag. Consequently a player is allowed to concentrate on getting chance flags until the timing of the next bonus game, and this realizes a new entertainment characteristic such that a chance game is playable while a base game is being played.

A gaming machine of the present invention, comprises: a base game offering a chance of winning a payout according to a predetermined combination; a chance game offering a chance of obtaining a chance flag which qualifies a player to join a bonus game offering a chance of winning a higher payout than the base game; a display displaying information which is based on a timing to run the bonus game; a storage unit storing the number of chance flags; an effect producing device which produces an effect for the base game and/or the chance game; an operation device which accepts an external input operation and outputs an input signal; and a controller which is programmed to perform the steps of: (d1) on the display, counting down time left until the timing to run the bonus game; (d2) running the base game and the chance game at the same time; (d3) determining and awarding a payout according to a result of the base game; (d4) determining the number of chance flags according to a result of the chance game, and awarding a resulting number of chance flags; (d5) accumulatively storing in the storage unit the number of chance flags awarded; (d6) awarding a payout determined according to a result of the bonus game which is run when the number of the chance flags stored in the storage unit equals or surpasses a predetermined number; (d7) causing the effect producing device to produce an effect for the base game and/or the chance game; (d8) determining whether the input signal has been output from the operation device; and (d9) if the input signal has been output, shortening the effect produced by the effect producing device.

According to the structure above, time left until the timing to run a bonus game is counted down on the display. Concurrently run are a base game offering a chance of winning a payout according to a predetermined combination and a chance game offering a chance of obtaining a chance flag which qualifies a player to join a bonus game offering a chance of winning a higher payout than the base game. A payout is determined according to a result of the base game and awarded. The number of chance flags is determined according to a result of the chance game, and a resulting number of chance flags are awarded. In the storage unit the number of chance flags awarded is accumulatively stored. A payout determined according to a result of the bonus game which is run when the number of the chance flags stored in the terminal storage unit equals or surpasses a predetermined number is awarded. An effect for a base game and/or a chance game is produced by the- effect producing device. There is determined whether an input signal has been output from an operation device. If it is determined that the input signal has been output, the effect by the effect producing device is shortened.

As a result of this, a player is able to play a base game and a chance game at the same time while time left until the timing of a bonus game is being counted down on the display, and hence the player is allowed to obtain a chance flag as well as a result of the base game. Consequently a player is allowed to concentrate on getting chance flags until the timing of the next bonus game, and this realizes a new entertainment characteristic such that a chance game is playable while a base game is being played.

Furthermore, the operation device which accepts an external input operation enables a player to shorten an effect by the effect producing device. This satisfies the player's desire to play as many games as possible within limited time before the next bonus game, thereby reducing the player's stress.

A playing method of a gaming machine of the present invention, which machine includes: a base game offering a chance of winning a payout according to a predetermined combination; a chance game offering a chance of obtaining a chance flag which qualifies a player to join a bonus game offering a chance of winning a higher payout than the base game; a display displaying information which is based on a timing to run the bonus game; and a storage unit storing the number of chance flags, the method comprising the steps of: (e1) displaying on the display the number of the base game before the timing to run the bonus game; (e2) running the base game and the chance game at the same time; (e3) determining and awarding a payout according to a result of the base game; (e4) determining the number of chance flags according to a result of the chance game, and awarding a resulting number of chance flags; (e5) accumulatively storing in the storage unit the number of chance flags awarded; and (e6) awarding a payout determined according to a result of the bonus game which is run when the number of the chance flags stored in the storage unit equals or surpasses a predetermined number.

According to the structure above, information based on the timing to run a bonus game is displayed on the display. Concurrently run are a base game offering a chance of winning a payout according to a predetermined combination and a chance game offering a chance of obtaining a chance flag which qualifies a player to join a bonus game offering a chance of winning a higher payout than the base game. A payout is determined according to a result of the base game and awarded. The number of chance flags is determined according to a result of the chance game, and a resulting number of chance flags are awarded. In the storage unit the number of chance flags awarded is accumulatively stored. A payout determined according to a result of the bonus game which is run when the number of the chance flags stored in the terminal storage unit equals or surpasses a predetermined number is awarded.

As a result of this above, a player is allowed to play a base game and a chance game at the same time while information based on a timing at which a bonus game is run is displayed on the display, and to obtain not only a result of the base game but also a chance flag. Consequently a player is allowed to concentrate on getting chance flags until the timing of the next bonus game, and this realizes a new entertainment characteristic such that a chance game is playable while a base game is being played.

### BRIEF DESCRIPTION OF THE DRAWINGS

FIG. 1 illustrates a gaming machine and a playing method thereof, according to the present invention.

FIG. 2 is a block diagram of the gaming machine.

FIG. 3 is an explanatory diagram illustrating a display state of an upper image display panel.

FIG. 4 is an explanatory diagram illustrating a display state of a lower image display panel.

FIG. 5 is an explanatory diagram illustrating a display state of a lower image display panel.

FIG. 6 is an explanatory diagram illustrating a display state of a shared display and a lower image display panel.

FIG. 7 illustrates symbols and code numbers of the respective symbols.

FIG. 8 is a perspective view illustrating an external appearance of the gaming machine.

FIG. 9 is a perspective view illustrating an external appearance of the gaming terminal.

FIG. 10 is a block diagram illustrating an electrical structure of the gaming terminal.

FIG. 11 is a block diagram illustrating an electrical structure of a center control unit.

FIG. 12 illustrates a JP chance data table.

FIG. 13 is a flowchart illustrating a boot process of the gaming machine.

FIG. 14 is a flowchart illustrating an initial process of the gaming machine.

FIG. 15 is a flowchart illustrating a game running process executed by the gaming machine.

FIG. 16 is a flowchart illustrating an effect skip process executed by the gaming machine.

FIG. 17 is a flowchart illustrating a countdown display process executed by the gaming machine.

FIG. 18 is a flowchart illustrating a progressive add process executed by the gaming machine.

FIG. 19 is a flowchart illustrating a JP chance add process executed by the gaming machine.

FIG. 20 is a flowchart illustrating a JP game running process executed by the gaming machine.

FIG. 21 is a flowchart illustrating a JP game timing determine process executed by the gaming machine.

FIG. 22 is an explanatory diagram illustrating a display state of an upper display panel of an alternative form of this embodiment.

### DESCRIPTION OF THE PREFERRED EMBODIMENTS

The following describes an embodiment of a gaming machine and a playing method thereof according to the present invention.

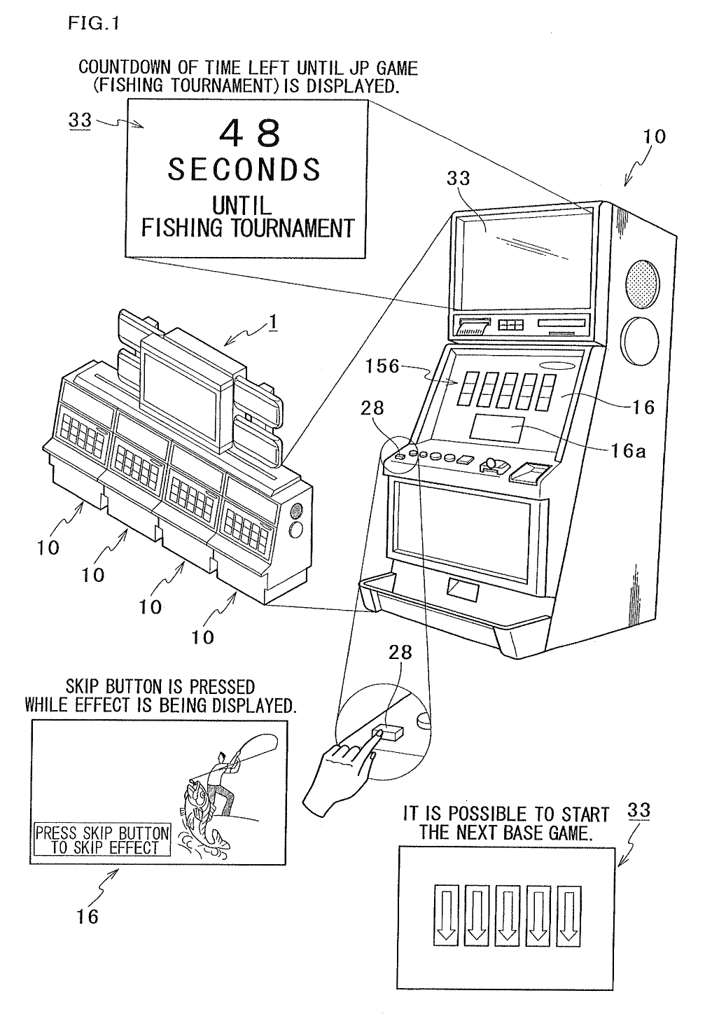

As shown in FIG. 1, the gaming machine is structured such that a base game as a base game and a chance game can be concurrently run while information based on a timing to run a JP game as a bonus game is being displayed on a display.

More specifically, the gaming machine includes: a base game configured to award a payout according to a predetermined combination; a chance game configured to provide a JP chance which is a chance flag qualifying a player to join a JP game configured to award a larger payout than the base game; a display displaying information based on a timing to run the JP game; a memory which stores the number of JP chances; and a controller programmed to operate as described in the following (a1) through (a6).

A step (a1) is configured to display on the display information based on a timing at which a JP game is run. A step (a2) is configured to concurrently run a base game and a chance game. A step (a3) is configured to determine and award a payout according to a result of the base game. A step (a4) is configured to determine the number of JP chances in accordance with a result of the chance game and award the determined number of JP chances. A step (a5) is configured to accumulatively store in the memory the number of awarded JP chances. A step (a6) is configured to award, at a predetermined timing, a payout determined in accordance with a result of a JP game which is run when the number of JP chances stored in the memory equals or surpasses a predetermined number.

That is to say, a gaming machine executes a playing method including the steps of: displaying on the display information based on a timing at which a JP game is run; running a base game and a chance game at the same time; determining and awarding a payout according to a result of the base game; determining the number of JP chances according to a result of the chance game, and awarding a resulting number of JP chances; accumulatively storing in the memory the number of awarded JP chances; and awarding a payout determined according to a result of the JP game which is run when the number of the JP chances stored in the memory equals or surpasses a predetermined number.

As a result of this above, a player is allowed to play a base game and a chance game at the same time while information based on a timing at which a JP game is run is displayed on the display, and to obtain not only a result of the base game but also a JP chance. Consequently a player is allowed to concentrate on getting JP chances until the timing of the next JP game, and this realizes a new entertainment characteristic such that a chance game is playable while a base game is being played.

A “gaming machine 1” of this embodiment includes several gaming terminals 10. A player is allowed to play a base game and a chance game at each gaming terminal 10. A player is also allowed to participate in a JP game which is concurrently run by each game terminal 10. The gaming machine maybe a multiplayer type as in this embodiment or a single-player type. Also, the gaming machine may be structured such that gaming machines such as slot machines, each of which presupposes an independent player, are connected to be able to exchange data, so as to form a multiplayer gaming machine as a whole.

Examples of the “display” of the present invention include a liquid crystal display, a CRT (cathode-ray tube), a plasma display, and an organic EL (Electro-Luminescence) display. The number of the display in each gaming machine may be one or more than one. In case of multiplayer type, each slot machine 1 may be provided with a display, or a large display shared by all gaming machines may be provided independently of the gaming machines. Specifically, the “gaming machine 1” of this embodiment includes one shared display 203 and terminal displays 101 of the respective gaming terminals 10.

“Base game” is a main game of each gaming machine, and a player primarily plays this game. A player bets a predetermined game value to play the base game, and the player is awarded a payout when obtaining a predetermined result from the base game. In this embodiment, a base game is a so-called slot game arranged so that symbols are variably displayed and a payout is awarded according to a stop result of varying display.

Specifically, “base game” of this embodiment is arranged such that several base symbols 180 are rearranged on respective base symbol arrangement areas 150a which are matrix-configured, and a state advantageous for a player is achieved when at least a predetermined number of base symbols 180 are displayed on the matrix. For example, the advantageous state includes a state where a payout is awarded, a state where a payout is added to a credit, and a state where a bonus game starts.

A “chance game” is a game to obtain a JP chance with which a player is able to qualify a JP game. In this embodiment, “chance game” is the same type of slot game as base game, and is playable at the same time as base game.

Specifically, “chance game” of this embodiment is a game in which JP symbols 180J are rearranged in JP symbol arrangement areas 150b which are matrix-configured, at the same time the base symbols 180 are rearranged in the based game. When the JP symbols 180J rearranged in the JP symbol arrangement areas 150b meet a winning condition, a JP chance is awarded.

Not limited to the slot game, the base game and the chance game may be roulette, horse racing, boat racing, or bicycle racing.

“JP game” is a special game which is run by a later-detailed center controller 100 at the same time in two or more gaming terminals 10 at a predetermined time interval. When this JP game results in a jackpot, a higher payout than a payout awarded from the base game is awarded. The JP game is run at a predetermined timing such as every 30 minutes or the like, and is run only for gaming terminals 10 having obtained at least a predetermined number (e.g. one) of JP chances. In this embodiment, the JP game is a virtual “Fishing Tournament” played by players who have obtained JP chances. The players playing the JP game are able to see their selected characters fishing on a shared display 203.

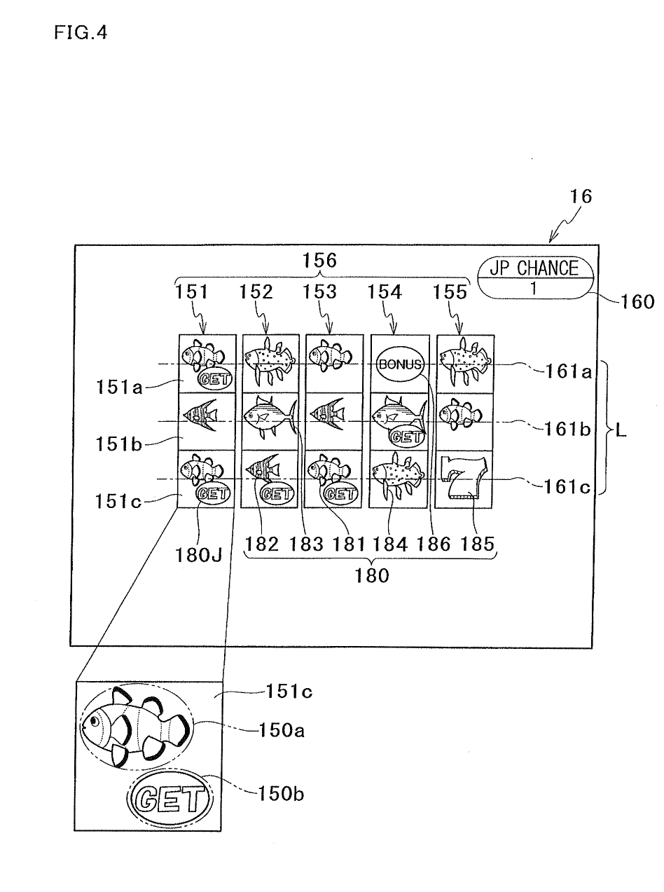

The “arrangement” in this embodiment means a state where the base symbols 180 and JP symbols 180J can be visually observed by a player. That is, as shown in FIG. 4, “arrangement” means that the base symbols 180 are displayed in the base symbol arrangement areas 150a, and the JP symbol 180J are displayed in the JP symbol arrangement areas 150b. Arranging the base symbols 180 and the JP symbols 180J again after dismissing them is referred to as “rearranging”.

Further, the “base symbols 180” are scatter symbols, which are used in a base game in each of the gaming terminals 10.

Each of the “scatter symbols” is a symbol whose arrangement results in a winning irrespective of any other conditions. Appearance of a predetermined number (e.g. five) of scatter symbols in a matrix 156 gives an advantage to a player. For example, the advantages include: a state where coins corresponding to the scatter symbols are paid out, a state where the number of coins to be paid out is added to a credit, a state where a bonus game is started.

JP symbols 180J are symbols used in a chance game in each gaming terminal 10. For each JP symbol 180J various types of winning combinations are determined in advance. A winning combination is a combination of JP symbols 180J stopping at a payline L, with which a player is awarded a JP chance. The pay line L is detailed later.

The “JP chance” qualifies a player to join the JP game. For each JP chance, a process of determining whether or not a jackpot is awarded is performed once.

“Jackpot” is awarded in the following way. A part of a game value bet by a player in each base game is subtracted and the subtracted parts are accumulated. When a player wins a JP game, he/she is awarded a part of or all of the accumulated game values.

In addition to the above, the gaming machine may be structured to randomly determine a timing to run a JP game. This provides a player with a game with further improved entertainment characteristic.

The gaming machine may be structured such that a base game and a chance game may be run at the same time while the number of playable base games before a JP game is run is being displayed on the display.

To be more specific, the gaming machine may include: a base game configured to award a payout according to a predetermined combination; a chance game configured to provide a JP chance which qualifies a player to join a JP game configured to award a larger payout than the base game; a display displaying information based on a timing at which the JP game is run; a memory which stores the number of JP chances; and a controller programmed to operate as described in the following (b1) through (b6).

A step (b1) is configured to display on the display the number of playable base games before the timing at which a bonus game is run. A step (b2) is configured to concurrently run a base game and a chance game. A step (b3) is configured to determine and award a payout according to a result of the base game. A step (b4) is configured to determine the number of JP chances in accordance with the result of the chance game and award the determined number of JP chances. A step (b5) is configured to accumulatively store in the memory the number of awarded JP chances. A step (b6) is configured to award a payout determined in accordance with a result of a bonus game which is run when the number of chance flags stored in the memory equals or surpasses a predetermined number.

As a result of this above, a player is allowed to play a base game and a chance game at the same time while the number of playable base games before the timing at which a JP game is run is displayed on the display, and to obtain not only a result of a base game but also a JP chance. Consequently a player is allowed to concentrate on getting JP chances while he/she plays a limited number of base games before the next JP game, and this realizes a new entertainment characteristic such that a chance game is playable while a base game is being played.

As illustrated in FIG. 1, the gaming machine may be structured such that a base game and a chance game may be run at the same time while time before the running of a JP game is being counted down on the display.

To be more specific, the gaming machine may include: a base game configured to award a payout according to a predetermined combination; a chance game configured to provide a JP chance which qualifies a player to join the JP game configured to award a larger payout than the base game; a display displaying information based on a timing at which the JP game is run; a memory which stores the number of JP chances; and a controller programmed to operate as described in the following (c1) through (c6).

A step (c1) is configured to count down, on the display, time before a JP game is run. A step (c2) is configured to concurrently run a base game and a chance game, and a step (c3) is configured to determine and award a payout according to a result of the base game. A step (c4) is configured to determine the number of JP chances in accordance with the result of the chance game and to award the determined number of JP chances. A step (c5) is configured to accumulatively store in the memory the number of awarded JP chances. A step (c6) is configured to award a payout determined in accordance with a result of a JP game which is run when the number of JP chances stored in the memory equals or surpasses a predetermined number.

As a result of this above, a player is allowed to play a base game and a chance game at the same time while time left until a JP game is run is counted down on the display, and to obtain not only a result of a base game but also a JP chance. Consequently a player is allowed to concentrate on getting JP chances until the timing of the next JP game, and this realizes a new entertainment characteristic such that a chance game is playable while a base game is being played.

As illustrated in FIG. 1, the gaming machine may be structured such that a base game and a chance game may be run at the same time while time before the running of a JP game is being counted down on the display. In addition, the gaming machine may be structured such that an effect produced by an effect producing device can be shortened by an operation device which accepts an external input operation.

To be more specific, the gaming machine may include: a base game configured to award a payout according to a predetermined combination; a chance game configured to provide a JP chance which qualifies a player to join a JP game configured to award a larger payout than the base game; a display displaying information based on a timing at which the JP game is run; a memory which stores the number of JP chances; an effect producing device which produces an effect for a base game and/or a chance game; an operation device which accepts an external input operation and outputs an input signal; and a controller programmed to operate as described in the following (d1) through (d9).

A step (d1) is configured to count down, on the display, time before a JP game is run. A step (d2) is configured to concurrently run a base game and a chance game. A step (d3) is configured to determine and award a payout according to a result of the base game. A step (d4) is configured to determine the number of JP chances in accordance with the result of the chance game and award the determined number of JP chances. A step (d5) is configured to accumulatively store in the memory the number of awarded JP chances. A step (d6) is configured to award a payout determined in accordance with a result of a JP game which is run when the number of JP chances stored in the memory equals or surpasses a predetermined number. A step (d7) is configured to cause the effect producing device to produce an effect for a base game and/or a chance game. A step (d8) is configured to determine whether an input signal is output from the operation device. A step (d9) is configured to shorten the effect produced by the effect producing device, if the input signal has been output.

As a result of this above, a player is allowed to play a base game and a chance game at the same time while time left until a JP game is run is counted down on the display, and to obtain not only a result of a base game but also a chance flag. Consequently a player is allowed to concentrate on getting JP chances until the timing of the next JP game, and this realizes a new entertainment characteristic such that a chance game is playable while a base game is being played.

Furthermore, the operation device which accepts an external input operation makes it possible to shorten an effect produced by the effect producing device. This satisfies the player's desire to play as many games as possible within limited time before the next JP game, thereby reducing the player's stress.

Examples of the “effect producing device” of the present invention include a display as in the case of the below-mentioned slot machine 1, a speaker, and a lamp.

(Function Blocks of Gaming Machine)

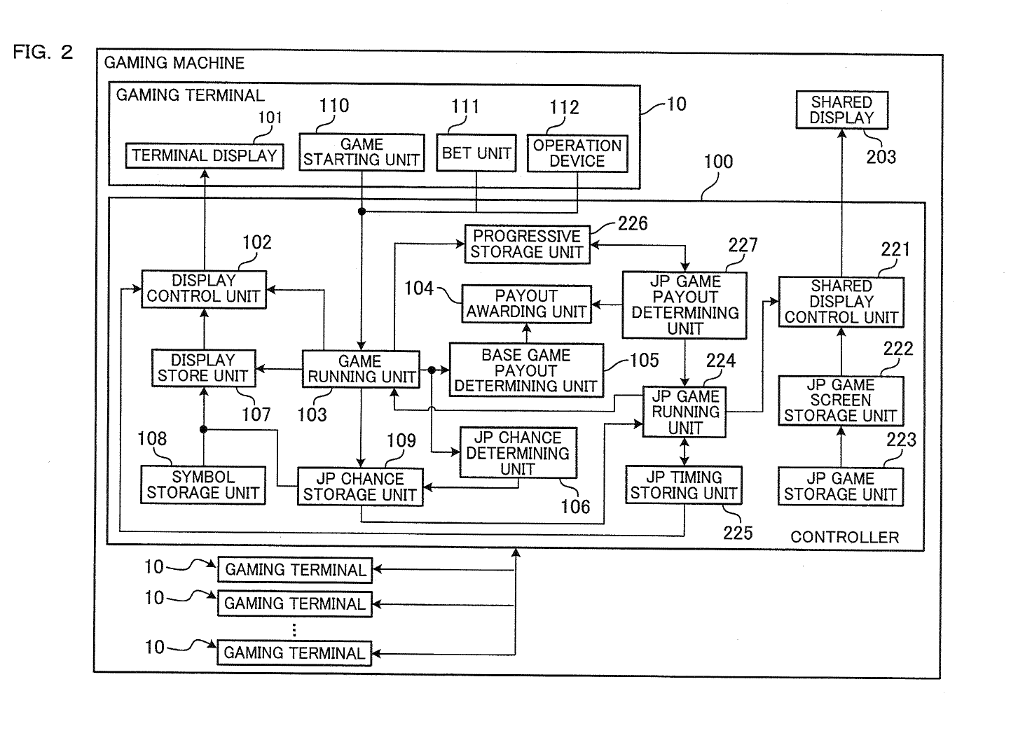

As illustrated in FIG. 2, the gaming machine configured as above has the shared display 203, the center controller 100, and the gaming terminals 10.

(Shared Display 203)

The shared display 203 displays thereon a virtual “Fishing Tournament” which is a JP game, as illustrated in FIG. 1. A specific structure of the shared display 203 will be detailed later.

(Gaming Terminal 10)

As illustrated in FIG. 2, each of the gaming terminals 10 includes a terminal display 101, a game starting unit 110, and a BET unit 111.

The terminal display 101 has, as shown in FIG. 1, a function of displaying the countdown of time until a JP. The terminal display 101 also has a function of displaying an effect image for a base game and/or a chance game. The game starting unit 110 has a function of outputting a game start signal, in response to an operation by the player. The game start signal output is then input to a later-detailed game running unit 103. The BET unit 111 has functions of receiving a bet entered through an operation by the player, and outputting a BET signal. The BET signal output is input to the later-detailed game running unit 103.

Each of the gaming terminals 10 may further include an operation device 112 which accepts an external input operation and outputs an input signal. The operation device 112 has a function of shortening an effect displayed on the terminal display 101, in response to an external input operation.

[Terminal Controller 100]

As shown in FIG. 2, the terminal controller 100 includes: a game running unit 103, a symbol storage unit 108, a JP chance storage unit 109, a display storage unit 107, and a display control unit 102.

The game running unit 103 runs a base game, triggered by the game start signal from the game starting unit 110. The base game is a game in which base symbols 180 are rearranged in the base symbol arrangement areas 150a of the terminal display 101. At the same time of running the base game, the game running unit 103 also runs a chance game in which JP symbols 180J are rearranged in the JP symbol arrangement areas 150b of the terminal display 101.

The symbol storage unit 108 stores the base symbols 180 and JP symbols 180J. The JP chance storage unit 109 accumulatively stores therein the number of JP chances obtained. The display storage unit 107 stores, as a symbol to be displayed, the base symbols 180 and JP symbols 180J in the symbol storage unit 108. In addition, the display store unit 107 stores effect image data for a base game and a chance game.

The control unit 102 performs setting so that the base symbol arrangement areas 150a for arranging therein the base symbols 180 overlap the JP symbol arrangement areas 150b for arranging therein the JP symbols. Further, the display control unit 102 reads out base symbols 180 from the display storage unit 107 and displays the base symbols 180 in the base symbol arrangement areas 150a, under the control of the game running unit 103. The display control unit 102 also reads out JP symbols 180J from the display storage unit 107 and displays the JP symbols 180J in the JP symbol arrangement areas 150b, under the control of the game running unit 103.

In addition, the display control unit 102 causes the terminal display 101 to display the countdown of time left until a JP game starts, based on the start timing of the JP game. The start timing of the JP game is stored in a later-detailed JP timing storing unit 225. The information which is displayed on the terminal display 101 by the display control unit 102 based on a timing at which a JP game is run is not limited to the above. The information may be the number of playable base games until a JP game starts.

The terminal controller 100 includes a base game payout determining unit 105, a JP chance determining unit 106, and a payout awarding unit 104.

The base game payout determining unit 105, under the control of the game running unit 103, determines whether to award a payout of a base game on the basis of the relations among base symbols 180 rearranged in the base symbol arrangement areas 150a. If it is determined that the payout is awarded, the base game payout determining unit 105 determines an amount of the payout and outputs a signal to the payout awarding unit 104.

The JP chance determining unit 106, under the control of the game running unit 103, determines whether to award a JP chance on the basis of the relations among the JP symbols 180 rearranged in the JP symbol arrangement areas 150b. If it is determined that JP chance is awarded, the JP chance determining unit 106 determines the number of JP chances and outputs a signal to the JP chance storage unit 109.

The payout awarding unit 104 awards the payout of the base game determined by the base game payout determining unit 105. Further, the payout awarding unit 104 awards a payout of a JP game determined by a later-detailed JP game payout determining unit 227, in response to a signal from the JP game payout determining unit 227. Note that a JP game is run when the number of JP chances stored in the JP chance storage unit 109 for each gaming terminal equals or surpasses a predetermined number. Further, an amount of the payout is determined by the JP game payout determining unit 227.

The controller 100 includes: a JP game running unit 224, a JP game storage unit 223, a JP game screen storage unit 222, and a shared display control unit 221.

The JP game running unit 224 determines, when predetermined time comes, whether the JP chance storage unit 109 stores a predetermined number or more of JP chances. The JP game running unit 224 runs a JP game on a gaming terminal 10 which stores the predetermined number or more of JP chances.

JP game storage unit 223 stores therein information regarding the JP game. The JP game screen storage unit 222 stores therein display information based on the information of the JP game stored in the JP game storage unit 223.

The shared display control unit 221, under the control of the JP game running unit 224, reads out the display information in the JP game screen storage unit 222, and causes the shared display 203 to perform displaying based on the display information.

In addition to the above, the controller 100 includes: a JP timing storing unit 225, a JP game payout determining unit 227, and a progressive storage unit 226.

The JP timing storing unit 225 is configured to store, when a JP game run by the JP game running unit 224 finishes, the timing of the next JP game.

Based on a result of the JP game, the JP game payout determining unit 227 determines whether to award a payout of the JP game, under the control of the JP game running unit 224. In other words, whether a jackpot is met is determined. If the JP game payout determining unit 227 determines that the JP game has resulted in a jackpot, the JP game payout determining unit 227 determines an amount of payout based on a progressive value stored in the progressive storage unit 226. The determination of whether a payout of a JP game is to be awarded is conducted for a number of times equal to the number of JP chances which each gaming terminal 10 has.

The progressive storage unit 226 accumulatively stores a progressive value indicated by a progressive signal received from the terminal controller 100.

Each block of the terminal controller 100 may be realized with hardware or with software as needed.

[Operation of Terminal Controller 100]

The following describes an operation of the terminal controller 100 in the above structure. First, the BET unit 111 receives a BET entered through an operation by a player. Further, a game start signal is output from the game starting unit 110 in response to the player's operation, and a base game and a chance game are run at the same time by the game running unit 103. When both of the games are run at the same time, the display control unit 102, under the control of the game running unit 103, displays base symbols 180 in the base symbol arrangement areas 150a. The display control unit 102 also displays JP symbols 180J in the JP symbol arrangement areas 150b, under the control of the game running unit 103.

Further, the base game payout determining unit 105 determines whether a payout is awarded, based on relations among the base symbols 180 rearranged in the base symbol arrangement areas 150a. If it is determined that a payout is awarded, the base game payout determining unit 105 determines an amount of a payout. The payout thus determined is awarded by the payout awarding unit 104.

In addition, while a base game and a chance game are being run, the display control unit 102 displays an effect on the terminal display 101 based on the effect image data stored in the display store unit 107. Alternatively, an effect image may be displayed for only one of base game and chance game.

If the game running unit 103 receives an operation signal from the operation device 112 while the effect image is being displayed, the display control unit 102 performs control so as to shorten the duration of display of the effect image, in accordance with a control signal from the game running unit 103.

Aside from the operations above, another process is executed so that information based on a timing to run a JP game is displayed on the terminal display 101. Specifically, after the finish of a JP game, the JP game running unit 224 determines the start timing of the next JP game. The thus determined start timing of the JP game is stored in the JP timing storing unit 225. The display control unit 102 displays on the terminal display 101 information based on a start timing of a JP game, which timing is stored in the JP timing storing unit 225. Specifically, the display control unit 102 counts down, on the terminal display 101, time left until the next JP game starts. Information displayed on the terminal display 101 is not limited to the above. Another example of information is the number of playable base games until the next JP game starts.

In the meanwhile, based on a start timing of a JP game stored in the JP timing storing unit 225, the JP game running unit 224 checks, for each game terminal 10, whether the JP chance storage unit 109 stores a JP chance. When there is a gaming terminal 10 which stores a predetermined number or more of JP chances, a JP game is run in that gaming terminal 10.

Then the JP game payout determining unit 227 determines whether a jackpot is met, based on a result of the JP game. If it is determined that a JP game has resulted in a jackpot, the JP game payout determining unit 227 determines a payout according to a progressive value stored in the progressive storage unit 226. The payout of the JP game thus determined is awarded by the payout awarding unit 104.

(Display State)

Now, the following discusses an example where the gaming machine is specifically embodied as a gaming machine 1.

A gaming machine 1 is placed in a gaming facility such as a casino. This gaming machine 1 runs a unit game which involves a game medium. The game medium is a coin, bill, or a value in the form of electronic information. However, the game medium in the present invention is not particularly limited. For example, a medal, token, electronic money, ticket or the like are also possible. Further, the ticket is not particularly limited and may be a later-described ticket with a barcode or the like ticket.

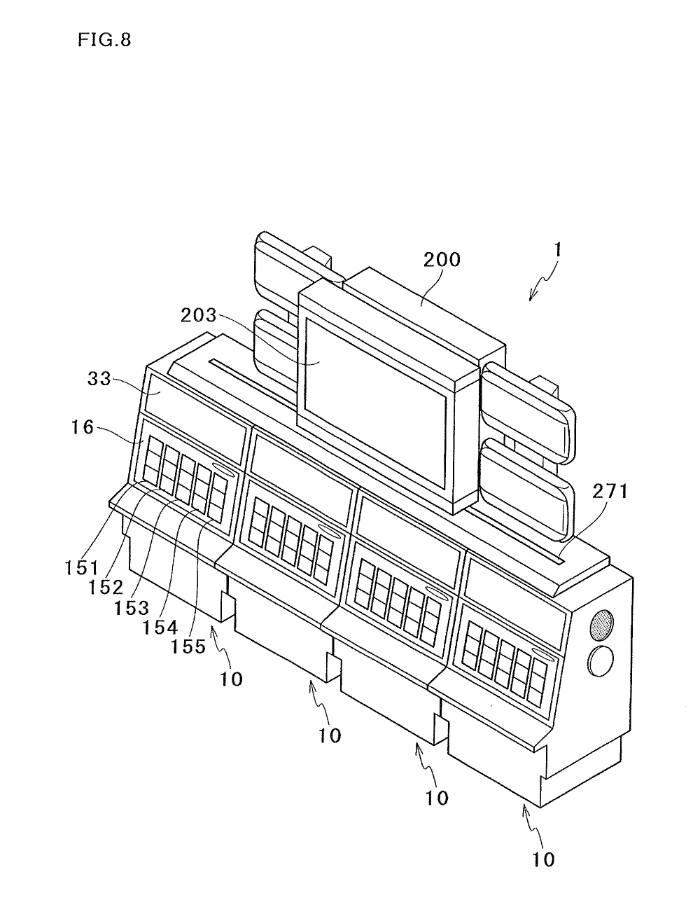

As illustrated in FIG. 8, the gaming machine 1 includes: gaming terminals 10 which run a base game independently from each other (the number of the gaming terminals 10 is 4 in this embodiment); a center control unit 200 connected to the gaming terminals 10, which is in communication with the gaming terminals 10 and runs a JP game; a shared display 203 which displays thereon an effect image related to a special game; a rail 271 which allows the shared display 203 to move to a position immediately above one of the gaming terminals 10; and a not-illustrated drive motor 270.

In addition, each gaming terminal 10 has an upper image display panel 33 and a lower image display panel 16. The upper image display panel 33 and the lower image display panel 16 function as the aforesaid terminal display 101. The upper image display panel 33 displays the countdown of time left until the timing of the next JP game. The lower image display panel 16 displays the following items according to need: notifying information of a base game and a chance game, for example rearrangement of base symbols 180 and JP symbols 180J; and various types of effect images.

(Display States of Upper Image Display Panel 33)

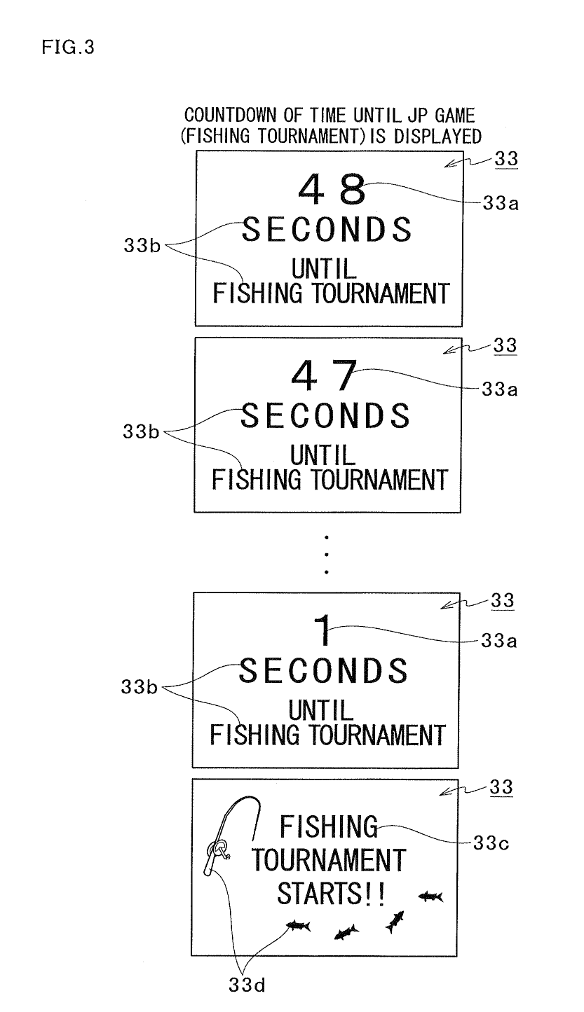

Referring to FIG. 3, display states of the upper image display panel 33 during a base game and a chance game are described.

As illustrated in FIG. 3, the upper image display panel 33 displays the countdown of time left until the timing of the next JP game. The upper image display panel 33 displays: a count down value image 33a indicating seconds left until the trimming of the next JP game; and a first template image 33b giving an explanation of the count down value image 33a. For example, when time left until the JP game is 48 seconds as shown by the uppermost upper image display panel 33 in FIG. 3, the upper image display panel 33 displays a count down value image 33a showing a numerical value of “48” and a first template image 33b showing the text which reads “seconds until Fishing Tournament”. Viewing the character string image “48 seconds until Fishing Tournament” displayed on the count down value image 33a allows a player to understand that a Fishing Tournament which is a JP game starts in 48 seconds. Further, as shown in FIG. 3, the count down value image 33a is updated in accordance with time left until the JP game. The player can therefore recognize at any time the timing when the JP game starts.

When the JP game starts, a second template image 33c indicating that the JP game has started and a JP game effect image 33d regarding the JP game are displayed as shown by the lowermost upper image display panel 33 in FIG. 3. Specifically displayed are a second template image 33c reading “Fishing Tournament Starts!!” and a JP game effect image 33d showing a fishing rod and fishes. This allows bystanders or the like of the gameplay to notify that the JP game has started.

(Display States of Lower Image Display Panel 16)

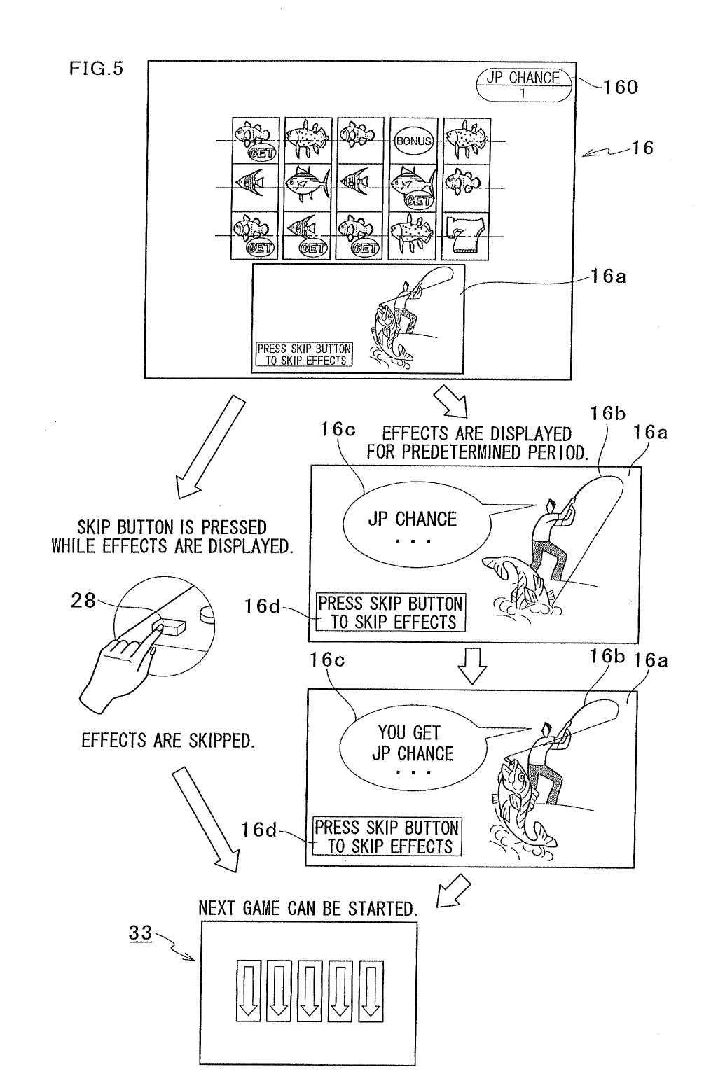

Referring to FIG. 4 and FIG. 5, the following specifically describes display states of the lower image display panel 16 in a base game and a chance game. The lower image display panel 16 is configured to arrange symbols in accordance with video reel. The lower image display panel 16 may have a mechanical structure adopting a reel device which rotates a reel to arrange symbols. Alternatively, the lower image display panel 16 may have an electric structure in which symbols are arranged by a video reel displayed as an image. Further, the lower image display panel 16 may adopt a combination of the mechanical structure (reel) and the electrical structure (video reel).

As shown in FIG. 4, the lower image display panel 16 displays a matrix-configured matrix 156. The matrix 156 is displayed at the center of the lower image display panel 16, and base symbols 180 and JP symbol 180J are arranged therein. Further, the matrix 156 is provided with display windows 151 to 155. In the display windows 151 to 155, a symbol column having base symbols 180 and a symbol column having JP symbols 180J are scrollably displayed. These columns overlap each other. The display windows 151 to 155 are respectively divided into upper stages 151a to 155a, central stages 151b to 155b, and lower stages 151c to 155c. The base symbols 180 and the JP symbols 180J are stopped (arranged) in each of the stages 151a to 155a, 151b to 155b, and 151c to 155c so that a base symbol 180 overlaps a JP symbol 180J.

For example, in FIG. 4, a “Clownfish” 181 which is a base symbol 180 is stopped in a base symbol arrangement area 150a in the upper stage 151a of the display window 151, and a “GET” which is a JP symbol 180J is stopped in the JP symbol arrangement area 150b of the same stage so as to overlap the “Clownfish”. Further, an “Angelfish” 182 is stopped in the base symbol arrangement area 150a in the central stage 151b of the display window 151, and no symbol is stopped in the JP symbol arrangement area 150b of the same stage. Further, a “Clownfish” is stopped in the base symbol arrangement area 150a in the bottom stage 151c of the display window 151, and a “GET” which is a JP symbol 180J is stopped in the JP symbol arrangement area 150b of the same stage. In short, the matrix 156 is a symbol matrix including five columns and three rows. The matrix 156 however is not limited to the one with the five-columns and three-rows.

Further, at the upper right of the lower image display panel 16 is displayed a JP chance display area 160, as illustrated in FIG. 4. The JP chance display area 160 displays the number of JP chances that a player has obtained. For example, in FIG. 4, the number of JP chances is “1”. As such, a player is able to join the JP game only once to be subjected to a process of determining whether a payout is awarded.

As illustrated in FIG. 4, the base symbols 180 and the JP symbols 180J are arranged so as to overlap one another, when a base game and a chance game are run at the same time in the gaming terminal 10. Specifically, as shown in the lower part of FIG. 4, a JP symbol 180J is arranged in the JP symbol arrangement area 150b below each base symbol arrangement area 150a.

As such, the base symbols 180 and the JP symbols 180J are concurrently arranged on the matrix 156 in the lower image display panel 16 to indicate results of a base game and a chance game. In this way a base game and a chance game can be run at the same time.

In a base game, base symbols 180 are arranged and a payout is awarded in accordance with the arrangement of the base symbols 180. In the case of FIG. 4, in the matrix 156 the number of displayed “Clownfish” 181, each of which is a base symbol 180, is not less than a predetermined number (5 in the present embodiment). In accordance with this, a payout is awarded.

In a chance game, arranged are only JP symbols 180J. In the case of FIG. 4, “GET” is displayed in each of the lower stage of 151c of the display window 151, the lower stage 152c of the display window 152, and the lower stage 153c of the display window 153. The chance game in this case therefore has resulted in a winning, and “1” is added to the number of JP chances. As the result, the JP chance display area 160 displays “2”.

As such, while information based on the timing to run a JP game is being displayed on the upper image display panel 33, the player can play a base game and a chance game at the same time on the lower image display panel 16, and hence the player is allowed to obtain a JP chance as well as a result of the base game. Consequently the player is allowed to concentrate on getting JP chances until the timing of the next JP game, and this realizes a new entertainment characteristic such that a chance game is playable while a base game is being played.

In addition to the above, the lower image display panel 16 has an effect image display area 16a where an effect image is displayed. This area 16a is provided below the matrix 156. In the effect image display area 16a, an effect image is displayed as a result of a chance game when an winning combination is met.

Specifically, as illustrated in FIG. 5, when a winning combination is met in a chance game, the effect image display area 16a displays a fishing image 16b showing a fisherman, a comment image 16c showing a comment of the fisherman, and a skip message image 16d showing a message for the player. These effect images are moving images each displayed for a predetermined period of time. When the fishing image 16b shows a fish being taken, the comment image 16c displays the entirety of the image which reads “You get JP chance . . . ”.

The aforesaid effect images may be skipped when a player presses a skip button 28 which is an operation device accepting an external input operation. That is to say, in response to the press of the skip button 28, an operation signal is output and the received operation signal triggers interruption of display control, with the result that the displaying of the effect images is stopped and hence the display time of the effect images is shortened.

While the aforesaid effect images are being displayed, the skip message image 16d which reads “Push skip button to skip effects” is kept displayed. This allows the player to recognize that the display time of the effect images can be shortened by pressing the skip button 28.

In this way, the effects produced by the effect producing device can be shortened by the operation device which accepts an external input operation. This satisfies the player's desire to play as many games as possible within limited time before the next JP game, thereby reducing the player's stress.

In the present embodiment the lower image display panel 16 displays effect images which may be shortened in response to the press of the skip button 28 as described above. The present invention, however, is not limited to this. For example. the effect images are not limited to the above. Furthermore, for example, the timing to display a shortenable effect image may be displayed while a base game and/or chance game is being run. Also, an effect image may be arranged so that the speed of a displayed comment increases in response to the press of the operation device.

[Display State of Shared Display 203]

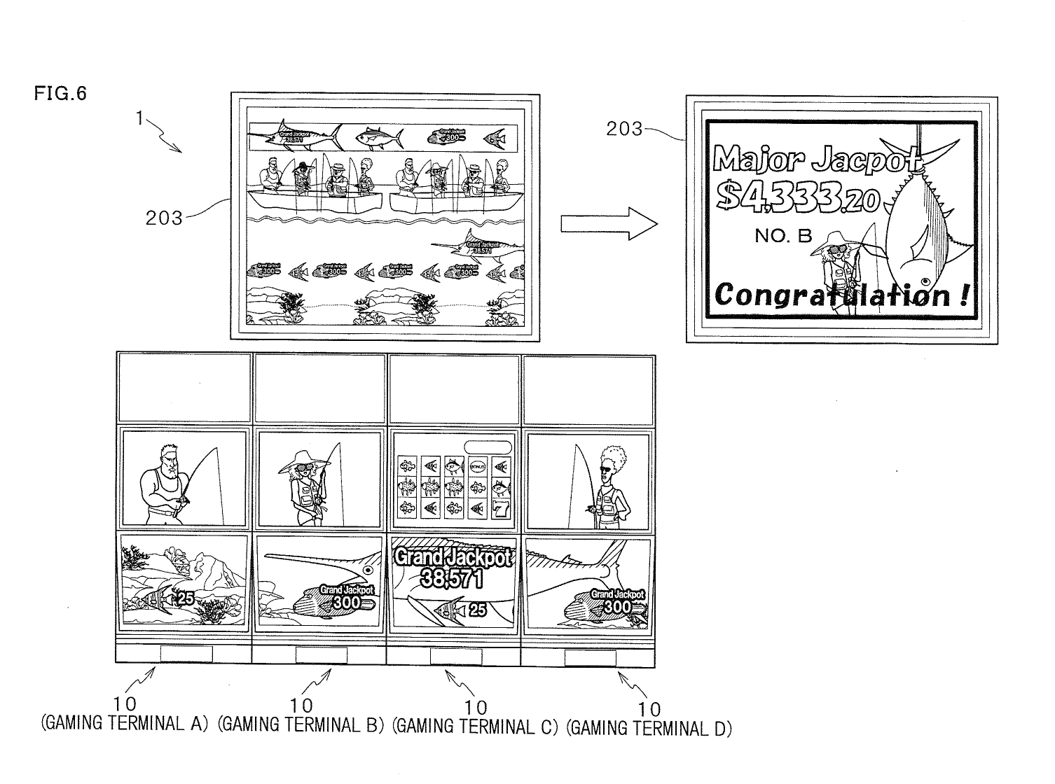

The following details an exemplary display state of the shared display 203 during the operations of the gaming machine 1 and the playing method thereof. As illustrated in FIG. 6, a player of each gaming terminal 10 (gaming terminal ID: A, gaming terminal ID: B, gaming terminal ID: C, and gaming terminal ID: D) can see a JP game displayed on the shared display 203. JP game is run at a predetermined timing. The JP game however is not run for a gaming terminal 10 having no JP chances. For example, in the case of FIG. 6, a JP game is not run in the gaming terminal 10 with the gaming terminal ID: C, and a base game is displayed on the terminal display 101 of the gaming terminal ID: C. On the other hand, a JP game runs in each of the remaining 3 gaming terminals 10 (gaming terminal ID: A, gaming terminal ID: B, gaming terminal ID: D). Further, in FIG. 6, jackpot is met in the gaming terminal 10 with the gaming terminal ID: B, and that win is displayed on the shared display 203.

As such, the shared display 203 allows players to play a JP game at the same time. With this, the players may be able to share the feeling while enjoying the JP game. Further, the JP game is run only for the gaming terminal 10 having at least a predetermined number of JP chances. Thus, a player who has won a predetermined number or more of JP chances is able to play the JP game, and another player who has not earned the predetermined number of JP chances is able to continue the base game. This may be advantageous in that the other player who has not earned the predetermined number of JP chances is able to enjoy continuing the base game without his/her pace being interrupted.

[Symbol, Winning Combination, or the Like]

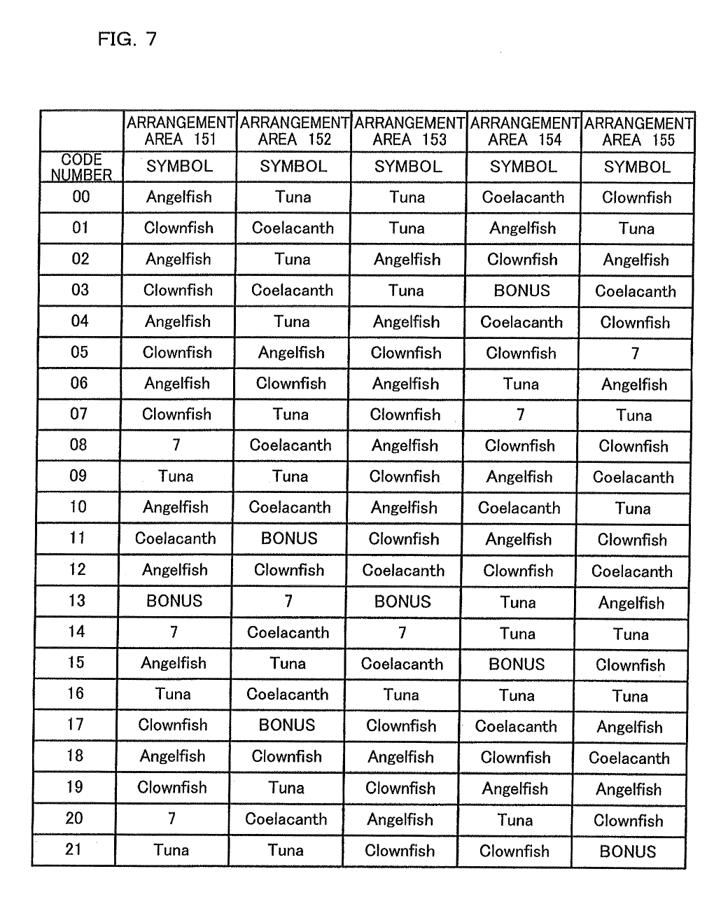

The base symbols 180 displayed in the matrix 156 of the lower image display panel 16 are arranged so that 22 symbols constitute a single symbol column as illustrated in FIG. 7. To each of the symbols constituting the columns is given one of code numbers 0 to 21. Each of the symbol columns has a combination of symbols including “Angelfish” 182, “Clownfish” 181, “7” 185, “Tuna” 183, “Coelacanth” 184, and “BONUS” 186. As illustrated in FIG. 4, the base symbols 180 are arranged in the respective base symbol arrangement areas 150a of the symbol columns.

Three successive symbols in the symbol columns are displayed (arranged) in the upper stages 151a to 155a, the middle stages 151b to 155b, and the lower stages 151c to 155c of the display windows 151 to 155, so that the symbols form a symbol matrix having five columns and three rows in the display windows 151 to 155. When a BET button and a start button are sequentially pressed in this order to start a game, symbols constituting the symbol matrix start to scroll. This scrolling of the symbols stops (rearrangement) after a predetermined period from the beginning of the scrolling.

Further, the base symbols 180 are “scatter symbols” which are such symbols which provide advantages to a player when a predetermined number or more of them are displayed in the matrix 156. For example, the advantages include: a state where coins corresponding to the scatter symbols are paid out, a state where the number of coins to be paid out is added to a credit, and a state where a bonus game is started.

For example, when five or more symbols of “Clownfish” 181 are rearranged in the matrix 156, five coins are paid out for each BET or a credit corresponding to five coins is added. In short, game media (game values) are awarded.

In another case, for example, when three or more symbols of “BONUS” 156 are rearranged in the matrix 156, a bonus is triggered and the gaming state shifts from a base game to a bonus game. When four or more symbols of “BONUS” 156 are rearranged in the matrix 156, 20 coins are paid out for each BET or a credit corresponding to 20 coins is added. In short, game media (game values) are awarded.

Here, a bonus game is a gaming state which provides a larger advantage than a base game. In this embodiment, the bonus game is a free game. The free game is a game allowing a player to play a game a predetermined number of times without betting a coin. No particular limitation is put on the bonus game, as long as it is a gaming state advantageous to the player, that is, it is more advantageous than the base game. For example, the bonus game may include a state where more game media are obtainable than in the base game, a state where a game medium is obtainable with higher probability than in the base game, a state where a game medium is less consumed than in the base game, and the like. Specifically, a free game, a second game, a feature game, and the like may be mentioned as examples of the bonus game.

The lower image display panel 16 displays three activated paylines L. The “pay line L” is used for determining a winning combination of the JP symbols 180J. That is, when the JP symbols 180J are rearranged on and out of the pay line L, a combination is determined for only the JP symbols 180J rearranged on the pay line. When the combination is recognized as a winning combination in consequence of the determination, a JP chance is awarded to the player in accordance with the winning combination. In other words, for example addition is made to the number of JP chances stored in the memory or the number of JP chances displayed on the JP chance display area 160 of the lower image display panel 16 is updated. Note that, not limited to three, the number of paylines L may be one, two, four, or more. When the number of pay lines L is two or more, the number of pay lines L activated may be determined according to a predetermined condition, such as the number of coins placed as a BET. In this case, the number of activated paylines L may be notified by a lamp or the like.

As illustrated in FIG. 4, the paylines L include a top line 161a traversing the upper stages 151a, 152a, 153a, 154a, and 155a, a central line 161b traversing the central stages 151b, 152b, 153b, 154b, and 155b, and a bottom line 161c traversing the lower stages 151c, 152c, 153c, 154c, and 155c. When three or more JP symbols 180J are successively rearranged on at least one of the paylines 161a to 161c, it is determined that a winning combination is met. For example, in the case of FIG. 4, a winning combination has been met because three JP symbols 180J are successively rearranged on the bottom line 161c.

In this way, a result of a base game is determined according to whether there are a predetermined number or more of rearranged base symbols 180, whereas a result of a chance game is determined according to whether JP symbols 180J are successively rearranged on the pay line L. As such, a base game and a chance game are similar slot games but adopt different methods of determining a result. Therefore a player may be possible to easily grasp the results of any games. This may release the stress of the player. The method of how to determine results of a base game and a chance game is not limited to the above. Both of them may be obtained by the scatter symbol method or by the winning combination method. Alternatively, a result of a base game is determined by the winning combination method whereas a result of a chance game is determined by the scatter symbol method.

Note that the lower image display panel 16 may have a credit value indicator and a payout value indicator. The credit value indicator displays a total value (hereinafter also referred to as total credit value) which a gaming terminal 10 can pay out to a player. The payout value indicator displays the number of coins to be paid out, when a predetermined number or more of base symbols 180 are rearranged.

[Mechanical Structure of Gaming Machine 1]

As illustrated in FIG. 8, the gaming machine 1 includes: gaming terminals 10 which run a base game independently from each other (the number of gaming terminals 10 is 4 in the present embodiment); a center control unit 200 connected to the gaming terminals 10, which is in communication with the gaming terminals 10 and runs a JP game; a shared display 203 which displays thereon an effect image related to the JP game; a rail 271 which allows the shared display 203 to move to a position immediately above one of the gaming terminals 10; and a not-illustrated drive motor 270.

Four gaming terminals 10 are laterally arranged in a parallel manner, with their terminal displays 101 (each including the lower image display panel 16 and the upper image display panel 33) facing forward. The rail 271 is arranged so as to cover the four gaming terminals 10. The shared display 203 is arranged on the rail 271 and its screen faces in the same direction as the terminal displays 101. The shared display 203 is arranged to be reciprocally movable by the drive motor 270. The center control unit 200 has, though unillustrated, electric or mechanical members for running a JP game and a cabinet to store these members. The center control unit 200 is arranged behind the shared display 203.

In the present embodiment, functions of the controller 100 are realized by the gaming terminals 10 and the center control unit 200. The present invention however is not limited to this.

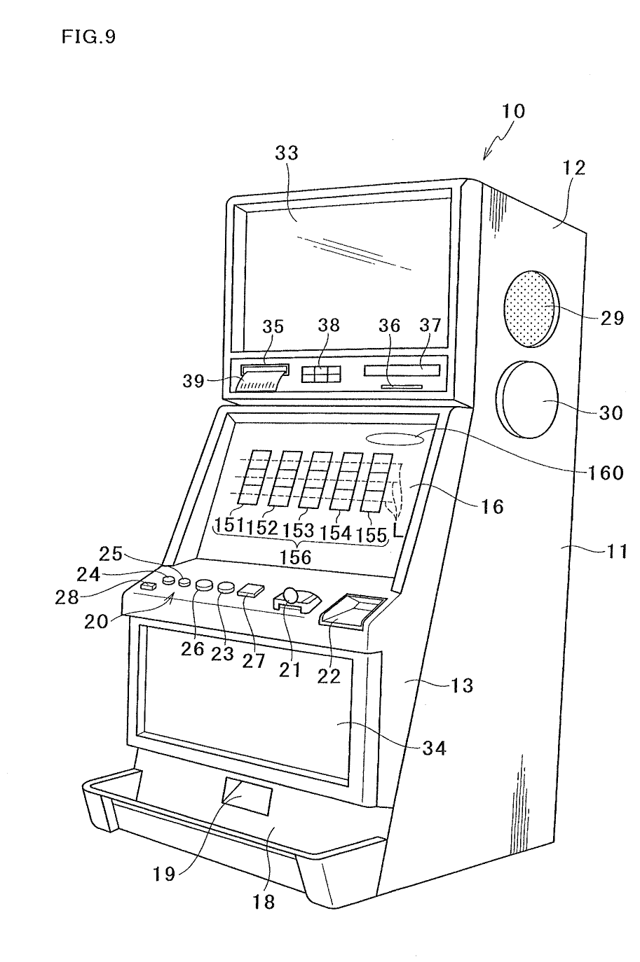

As illustrated in FIG. 9, the gaming terminal 10 includes: a cabinet 11, a top box 12 provided above the cabinet 11, and a main door 13 provided on the front surface of the cabinet 11. The main door 13 has a lower image display panel 16. The lower image display panel 16 has a transparent liquid crystal panel for displaying various information. The lower image display panel 16 displays display windows 151 to 155 and a matrix 156 for arranging therein base symbols 180 and JP symbols 180J. Further, the lower image display panel 16 displays as needed various information and effect images related to games. Further, at the upper right of the lower image display panel 16 is displayed a JP chance display area 160.

This embodiment deals with a case where the lower image display panel 16 electrically displays base symbols 180 and JP symbols 180J in such a way that a base symbol 180 overlaps a JP symbol 180J, with the result that the symbols are arranged in five rows/three columns. However, the present invention is not limited to this.

Below the lower image display panel 16 provided are a control panel 20, a coin insertion slot 21, and a bill validator 22. The control panel 20 is provided with various buttons 23 to 27. These buttons 23 to 27 allow a player to input instructions related to a game played by the player. Through the coin insertion slot 21, a coin is received in the cabinet 11.

The control panel 20 includes: a spin button 23, a change button 24, a cashout button 25, a 1-BET button 26, a maximum BET button 27, and a skip button 28. The spin button 23 is for inputting an instruction to start symbol scrolling. The change button 24 is used to ask a staff person in the gaming facility for exchange of money. The cash out button 25 is for inputting an instruction to pay out coins corresponding to the total credit-value into the coin tray 18, via a coin payout opening 19.

The 1-BET button 26 is used for betting one coin out of those corresponding to the total credit value. The maximum BET button 27 is used for betting, out of those corresponding to the total credit value, a maximum number of coins (e.g., fifty coins) which can be bet in one game. Note that the number of coins corresponding to 1 BET is not limited to the above.

The bill validator 22 validates whether bill is genuine or not and receives the genuine bill into the cabinet 11. Note that the bill validator 22 is capable of reading a barcode attached to a later-mentioned ticket 39 having a barcode (hereinafter simply referred to as ticket 39). When the bill validator 22 reads the ticket 39, it outputs to the main CPU 41 a read signal representing information having read from the barcode.

On the lower front surface of the main door 13, that is, below the control panel 20, a berry glass 34 is provided. On the belly glass 34, a character of a gaming terminal 10 or the like is drawn. On the front surface of top box 12 is provided an upper image display panel 33. The upper image display panel 33 has a liquid crystal panel and displays an effect image, introduction to the game, rules of the game, or the like.

Further, the top box 12 has a speaker 29 for performing an audio output and a lamp 30. Below the upper image display panel 33 are provided a ticket printer 35, a card reader 36, a data displayer 37, and a keypad 38. The ticket printer 35 prints, on to a ticket, a barcode having encoded data containing credit-value, date and time, identification number of a gaming terminal 10 or the like, thereby issuing a ticket 39 having a barcode attached thereto. A player can play a game in another gaming terminal 10 with the ticket 39 having the barcode, or exchange the ticket 39 with bill or the like at a change booth or the like of the game arcade.

The card reader 36 reads/writes data from/into a smart card. The smart card is carried by a player, and stores therein data for identifying the player, data relating to a history of games played by the player, or the like.

The data displayer 37 includes a fluorescent display or the like, and displays the data read by the card reader 36 and the data input by the player through the keypad 38. The keypad 38 is for entering instructions or data relating to issuing of a ticket or the like.

[Electrical Structure of Gaming Machine 1]

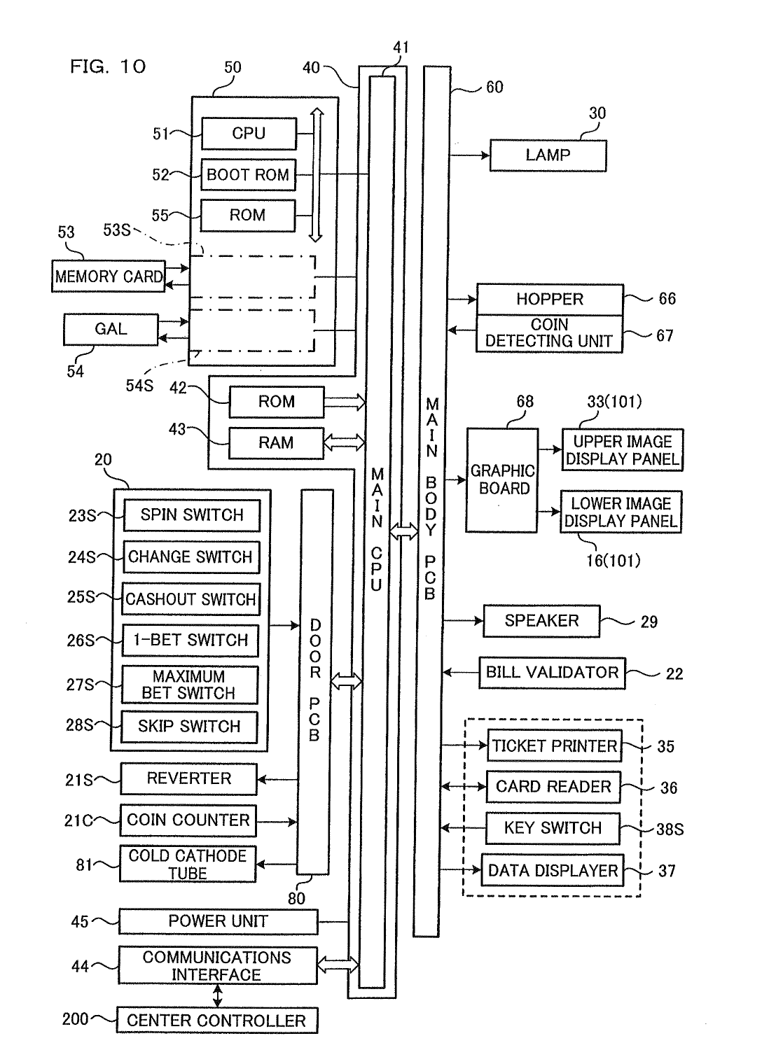

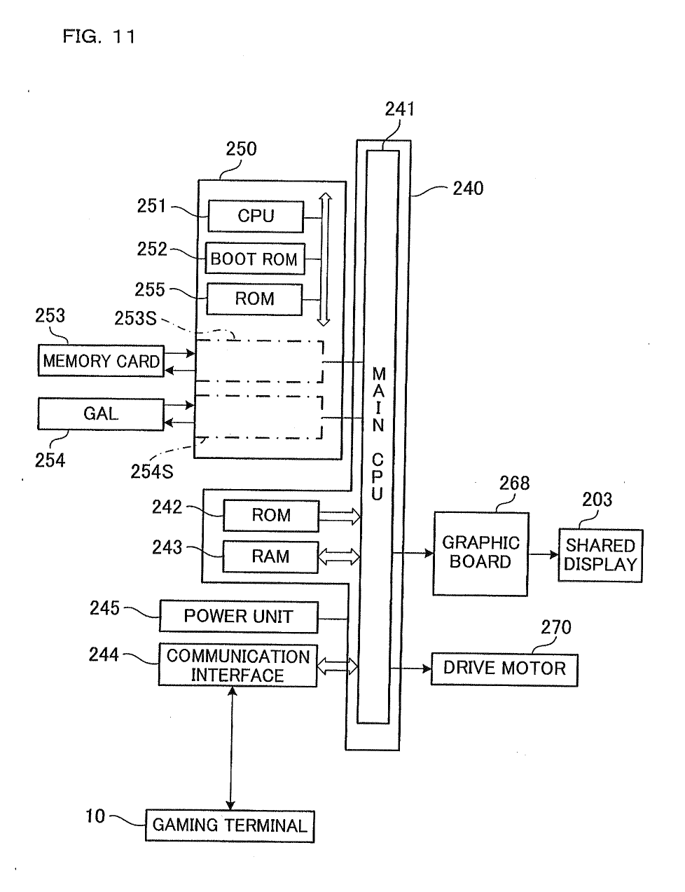

FIGS. 10 and 11 are block diagrams each illustrating an electrical structure of the entire gaming machine 1.

[Electrical structure of Gaming Terminal 10]

FIG. 10 is a block diagram illustrating an electrical structure of the gaming terminal 10. As illustrated in FIG. 10, the cabinet 11 includes therein a control unit having at least one of the functions of a terminal controller 100. The control unit includes, as shown in FIG. 10, a motherboard 40, a main body PCB (Printed Circuit Board) 60, a gaming board 50, a door PCB 80, various switches, sensors, or the like.

The gaming board 50 is provided with a CPU (Central Processing Unit) 51, a ROM 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a stop symbol determining program. The stop symbol determining program is a program for determining: base symbols 180 (code numbers corresponding to the symbols) to be stopped in the base symbol arrangement area 150a; and JP symbols 180J (code numbers corresponding to the symbols) to be stopped in the JP symbol arrangement area 150b. This stop symbol determining program contains sets of symbol weighting data respectively corresponding to various payout rates (e.g., 80%, 84%, 88%). Each set of the symbol weighting data indicates, for each of the display windows 151 to 155, a code number of each symbol and at least one random numerical value allotted to the code number. The numerical value is a value within a predetermined range of 0 to 256 for example.

The payout rate is determined based on payout rate setting data output from the GAL 54. Based on a set of the symbol weighting data corresponding to the payout rate determined, a symbol to be stopped is determined.

The memory card 53 stores therein various types of data for use in the game programs and the game system programs. For example, the memory card 53 stores a table listing combinations of a base symbol 180 to be displayed on the display windows 151 to 155 of FIG. 4 and an associated range of random numerical values. This data is transferred to the RAM 43 of the motherboard 40, at the time of running a game program.

The card slot 53S is structured so as to allow the memory card 53 to be attached/detached to/from the card slot 53S. This card slot 53S is connected to the motherboard 40 through an IDE bus. Thus, the type and content of a game run by a gaming terminal 10 can be modified by detaching the memory card 53 from the card slot 53S, write a different game program and a different game system program into the memory card 53, and inserting the memory card 53 back into the card slot 53S.

Each of the game programs includes a program related to the progress of the game and/or a program for causing a transition to a bonus game. Each of the game programs includes image data and audio data output during the game.

The GAL 54 has input and output ports. When the GAL 54 receives data via the input port, it outputs data corresponding to the input data from its output port. This data from the output port is the payout rate setting data described above.

IC socket 54S is structured so as to allow the GAL 54 to be attached/detached to/from the IC socket 54S. The IC socket 54S is connected to the motherboard 40, via a PCI bus. Thus, the payout rate setting data to be output from GAL 54 can be modified by: detaching the GAL 54 from the IC socket 54S, overwriting the program stored in the GAL 54, and attaching the GAL 54 back to the IC socket 54S.

The CPU 51, the ROM 55 and the boot ROM 52 connected through an internal bus are connected to the motherboard 40 through the PCI bus. The PCI bus communicates signals between the motherboard 40 and the gaming board 50 and supplies power from the motherboard 40 to the gaming board 50. The ROM 55 stores country identification information and an authentication program. The boot ROM 52 stores a preliminary authentication program and a program (boot code) for enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified. In short, the preliminary authentication program authenticates the authentication program.

The motherboard 40 is provided with a main CPU 41, a ROM (Read Only Memory) 42, a RAM (Random Access Memory) 43, and a communication interface 44.

The main CPU 41 has at least one of the functions of a terminal controller 100 controlling the entire gaming machine 1, and the main CPU 41 controls a gaming terminal 10. In particular, the main CPU 41 controls the following operations: an operation of outputting a signal instructing variable-displaying of symbols 180 to the graphic board 68, which is performed in response to pressing of the spin button 23 after betting of credit; an operation of determining symbols 180 to be stopped after the variable-displaying of symbols 180; and an operation of stopping the symbols 180 thus determined in the display window 151 to 155.

In other words, the main CPU 41 serves as an arrangement controller which arranges symbols to form a new symbol matrix through scrolling of symbols displayed on the lower image display panel 16. This main CPU 41 therefore determines symbols to be arranged in a symbol matrix by selecting symbols to be arranged from various kinds of symbols. Then, the main CPU 41 executes arrangement control to stop scrolling the symbols to present the symbols thus determined.

The ROM 42 stores a program such as BIOS (Basic Input/Output System) run by the main CPU 41, and permanently-used data. When the BIOS is run by the main CPU 41, each of peripheral devices is initialized and the game program and the game system program stored in the memory card 53 are read out through the gaming board 50. The RAM 43 stores data or a program used for the main CPU 41 to perform a process.

In addition, the ROM 242 stores a gaming terminal ID unique to each gaming terminal 10. When various signals are transmitted to the center control unit 200, gaming terminal ID information is added to the header or the like. This allows the center control unit 200 to identify the sender of each of the signals. A gaming terminal ID is, for example, an IP (Internet Protocol) address of each gaming terminal 10.

In addition to the above, the RAM 43 stores a JP timing which is based on a JP timing signal transmitted from the center control unit 200. This JP timing is information regarding timing to start a JP game, and is determined after a JP game finishes in the center control unit 200. The JP timing signal is a signal including information generated based on the JP timing, and this signal is transmitted from the center control unit 200.

The communication interface 44 is provided to communicate with a host computer and the like equipped in the gaming facility, through the network (communication line). The communication interface 44 is also for communicating with the center control unit 200 through a communication line. Further, a main body PCB (Printed Circuit Board) 60 and a door PCB 80 are connected to the motherboard 40, through USB (Universal Serial Bus). Further, the motherboard 40 is connected to a power unit 45. The power unit 45 supplies power to the motherboard 40 to boot the main CPU 41 thereof. Meanwhile, the power unit 45 supplies power to the gaming board 50 through the PCI bus to boot the CPU 51 thereof.

The main body PCB 60 and door PCB 80 are connected to various devices or units which generate signals to be input to the main CPU 41, and various devices or units whose operations are controlled by signals from the main CPU 41. Based on a signal input to the main CPU 41, the main CPU 41 runs the game program and the game system program stored in the RAM 43, to perform an arithmetic process. Then, the CPU 41 stores the result of the arithmetic process in the RAM 43, or transmits a control signal to the various devices and units to control them based on the result.

The main body PCB 60 is connected with a lamp 30, a hopper 66, a coin sensor 67, a graphic board 68, the speaker 29, a bill validator 22, a ticket printer 35, a card reader 36, a key switch 38S, and a data displayer 37.

The lamp 30 is turned on/off on the basis of a control signal from the main CPU 41.

The hopper 66 is mounted in the cabinet 11 and pays out a predetermined number of coins from a coin outlet 19 to the coin tray 18, based on a control signal from the main CPU 41. The coin sensor 67 is provided inside the coin outlet 19, and outputs a signal to be input to the main CPU 41 upon sensing that a predetermined number of coins have been delivered from the coin outlet 19.

The graphic board 68 controls image displaying of upper image display panel 33 and the lower image display panel 16, based on a control signal from the main CPU 41. Further, the graphic board 68 is provided with a VDP (Video Display Processor) for generating image data on the basis of a control signal from the main CPU 41, a video RAM for temporarily storing the image data generated by the VDP, or the like. Note that image data used at the time of generating the image data by the VDP is in a game program which is read out from the memory card 53 and stored in the RAM 43.

The bill validator 22 reads an image on the bill and takes only those recognized as to be genuine into the cabinet 11. When taking in a genuine bill, the bill validator 22 outputs an input signal indicating the value of the bill to the main CPU 41. The main CPU 41 stores into the RAM 43 a credit-value corresponding to the value of the bill indicated by the signal.

The ticket printer 35 prints a barcode on to a ticket to issue a ticket 39 having the barcode. The barcode contains encoded data such as credit-value stored in the RAM 43, date and time, identification number of the gaming terminal 10, or the like, based on a control signal from the main CPU 41.

The card reader 36 reads out data from the smart card and transmits the data to the main CPU 41. Further, the card reader 36 writes data into the smart card based on the control signal output from the main CPU 41. The key switch 38S is mounted to the keypad 38, and outputs a signal to the main CPU 41 in response to an operation of the keypad 38 by the player. The data displayer 37 displays, based on a control signal from the main CPU 41, the data read by the card reader 36 or the data input by the player through the key pad 38.

The door PCB 80 is connected to a control panel 20, a reverter 21S, a coin counter 21C, and a cold cathode tube 81. The control panel 20 is provided with: a spin switch 23S associated with the spin button 23; a change switch 24S associated with the change button 24; a cashout switch 25S associated with the cashout button 25; a 1-BET switch 26S associated with the 1-BET button 26; a maximum BET switch 27S associated with the maximum BET button 27, and a skip switch 28S associated with the skip button 28. Each of the switches 23S to 28S outputs a signal to the main CPU 41, when a player presses the associated button.

The coin counter 21C is provided within the coin insertion slot 21, and identifies whether the coin inserted into the coin insertion slot 12 by the player is genuine. A coin except the genuine coin is discharged from the coin outlet 19. In addition, the coin counter 21C outputs an input signal to the main CPU 41 upon detection of a genuine coin.

The reverter 21S is operated on the basis of the control signal output from the main CPU 41 and distributes a coin, which is recognized as a genuine coin by the coin counter 21C, to a not-illustrated cash box or hopper 66 mounted in the gaming terminal 10. In other words, when the hopper 66 is full of the coins, the genuine coin is distributed into the cash box by the reverter 21S. On the other hand, when the hopper 66 is not yet full with the coins, the genuine coin is distributed into the hopper 66. The cold cathode tube 81 functions as a backlight mounted to rear sides of the lower image display panel 16 and the upper image display panel 33. This cold cathode tube 81 turns on according to a control signal from the main CPU 41.

[Electrical Structure of Center Controller 200]

FIG. 11 is a block diagram illustrating an electrical structure of the center control unit 200. The center control unit 200 is provided therein with a control unit. As illustrated in FIG. 11, the control unit includes a motherboard 240, a gaming board 250, an actuator, or the like.

The gaming board 50 is provided with a CPU 251, a ROM 255, a boot ROM 252, a card slot 253S corresponding to a memory card 253, and an IC socket 254S corresponding to a GAL 254. The CPU 251, the ROM 255, and the boot ROM 252 are connected to one another through an internal bus.

The memory card 53 stores therein a game program, a game system program, and various types of data for use in the game program and the game system program. Specifically, the memory card 53 stores data such as a program for managing each gaming terminal 10 and a program for running a JP game. Such programs and data are transmitted to the motherboard 240 at the time of boot of the center control unit 200, running of a program, and so forth.

Each of the game program includes a program related to the progress of the JP game. Each of the game programs also includes image data and audio data output during the JP game.

The gaming board 250 has, as illustrated in FIG. 10, a similar structure to the gaming board 50 of the gaming terminal 10, and hence a further explanation of the structure is not given.

The motherboard 240 includes a main CPU 241, a ROM 242, a RAM 243, and a communication interface 244.

The main CPU 41 has at least one of the functions of a terminal controller 100 controlling the entire gaming machine 1, and the main CPU 41 controls a control unit 200. The ROM 242 stores a program run by the main CPU 241, and permanently-used data. The RAM 243 stores data or a program used for the main CPU 241 to perform a process. The communication interface 244 communicates with the gaming terminals 10 through a communication line.

The ROM 242 also stores a program which extracts random numerical values. The random numerical value extraction program is run by the main CPU 41. In the present embodiment, random numerical value extraction is carried out by a program. The present invention however is not limited to this arrangement. For example, there may be provided a random number generator generating a predetermined range of random numerical values and a sampling circuit extracting any random numerical value from the values generated by the random number generator.

In addition, the RAM243 stores progressive values accumulatively supplied from each gaming terminal 10. The progressive values are used as the source of payout when jackpot is met in a JP game. The RAM243 also stores the timing of the next JP game, which is determined when the current JP game finishes.

Further, the center control unit 200 includes a graphic board 268 and a drive motor 270 which serve as main actuators.

The graphic board 268 has the same structure as that of the graphic board 68, except in that the graphic board 268 controls image displaying of the shared display 203 based on a control signal from the main CPU 241.

The drive motor 270 is a stepping motor and is connected to a not-shown drive wheel. The drive motor 270 is driven by a control signal from the main CPU 241, and rotates the drive wheel to move the shared display 203.

Further, the center control unit 200 includes a power unit 245. The power unit 245 serves as a power source for supplying power to the motherboard 240.

(JP Chance Data Table)

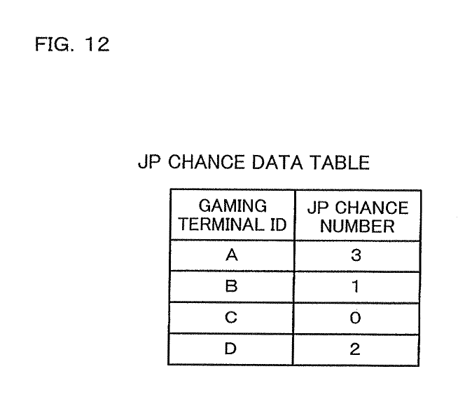

Referring to FIG. 12, a JP chance data table is described. The JP chance data table is stored in the RAM 243 of the center control unit 200. The JP chance data table has a gaming terminal ID list and a JP chance number list. The gaming terminal ID list stores a gaming terminal ID used for identifying a game terminal 10 connected to and in communication with the center control unit 200. The JP chance number list stores the number of JP chances of each gaming terminal 10, in association with gaming terminal IDs.

Specifically, when a player at the gaming terminal 10 with the gaming terminal ID “A” is awarded a JP chance in a chance game, the gaming terminal 10 transmits a JP chance signal to the center control circuit 200. This JP chance signal includes gaming terminal ID information indicating “A” and JP chance number information indicating the number of awarded JP chances. Receiving the JP chance signal, the center control unit 200 increases, in the JP chance data table, the JP chance number associated with the gaming terminal ID.

In a JP game run by the center control unit 200, when the gaming terminals 10 participate in the JP game, the JP chance number corresponding to each of the participating gaming terminals 10 is decremented in the JP chance data table, each time whether jackpot is met or not is determined. [Operation of Gaming Machine 1: Boot Process]

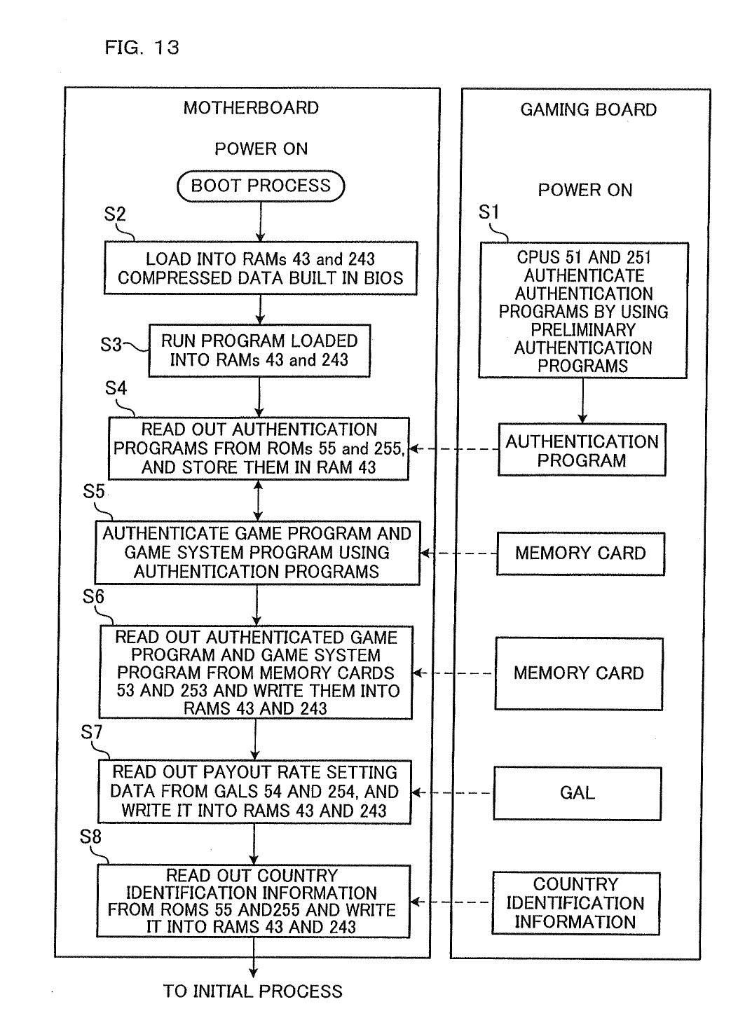

The following describes a boot process routine which takes place in the gaming machine 1. Upon powering on the gaming machine 1, the mother board 240 and gaming board 250 in the center controller 200, and the mother board 40 and the gaming board 50 in the gaming terminal 10 execute the boot process routine illustrated in FIG. 13. The memory cards 53 and 263 are assumed to be inserted into the card slots 53S and 253S of the gaming boards 50 and 250, respectively. Further, the GALs 54 and 254 are assumed to be attached to the IC sockets 54S and 254S, respectively.

First, turning on the power switch of (powering on) the power units 45 and 245 boots the motherboards 40 and 240 and the gaming boards 50 and 250. Booting the motherboards 40 and 240 and the gaming boards 50 and 250 starts separate processes in parallel. Specifically, in the gaming boards 50 and 250,the CPUs 51 and 251 read out preliminary authentication programs stored in the boot ROMs 52 and 262, respectively. Then, preliminary authentication is performed according to the read out programs so as to confirm and authenticate that no modification is made to authentication programs, before reading them in the motherboards 40 and 240, respectively (S1). Meanwhile, the main CPUs 41 and 241 of the motherboards 40 and 240 run BIOS stored in the ROMs 42 and 242 to load into the RAMs 43 and 243 compressed data built in the BIOS, respectively (S2). Then, the main CPUs 41 and 241 run a procedure of the BIOS according to the data loaded into the RAMs 43 and 243 so as to diagnose and initialize various peripheral devices (S3).

The main CPUs 41 and 241, which are respectively connected to the ROMs 55 and 255 of the gaming boards 50 and 250 via PCI buses, read out authentication programs stored in the ROMs 55 and 255 and stores them in the RAMs 43 and 243 (S4). During this step, the main CPUs 41 and 241 each derives a checksum through ADDSUM method (a standard check function) which is adopted in a standard BIOS, and store the authentication programs into RAMs 43 and 243 while confirming if the operation of storing is carried out without an error.

Next, the main CPUs 41 and 241 each checks what connects to the IDE bus. Then, the main CPUs 41 and 241 access, via the IDE buses, to the memory cards 53 and 253 inserted into the card slots 53S and 253S, and read out game programs and game system programs from the memory cards 53 and 253, respectively. In this case, the CPUs 41 and 241 each reads out four bytes of data constituting the game program and the game system program at one time. Next, the CPUs 41 and 241 authenticate the game program and the game system program read out to confirm and prove that these programs are not modified (S5).

When the authentication properly ends, the main CPUs 41 and 241 write and store the authenticated game programs and game system programs in RAMs 43 and 243 (S6).

Next, the main CPUs 41 and 241 access, via the PCI buses, to the GALs 54 and 254 attached to the IC socket 54S 254S, and read out payout rate setting data from the GALs 54 and 254, respectively. The payout rate setting data read out is then written and stored in the RAMs 43 and 243 (S7).

Next, the main CPUs 41 and 241 read out, via the PCI buses, country identification information stored in the ROMs 55 and 255 of the gaming boards 50 and 255, respectively. The country identification information read out is then stored in the RAMs 43 and 243 (S8).

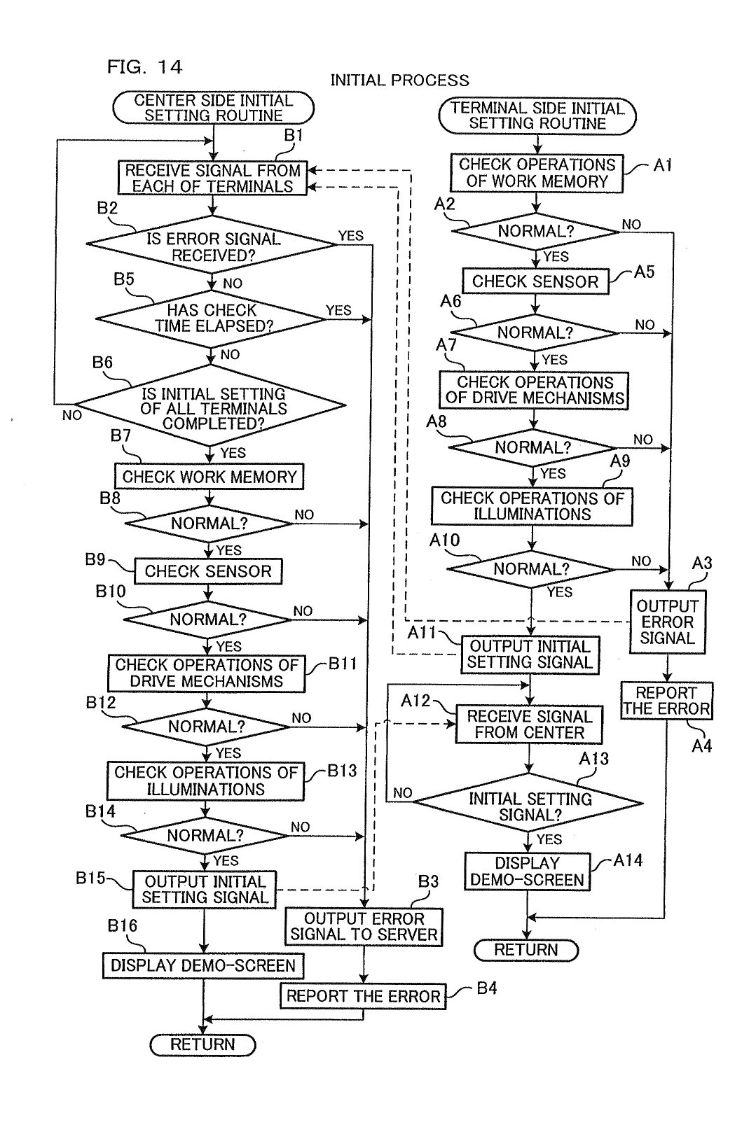

After this, the main CPUs 41 and 241 each performs an initial process of FIG. 14.

[Operation of Gaming Machine 1: Initial Process]

The following describes an initial process which takes place in the gaming machine 1. When the boot process of FIG. 13 is completed, the center control unit 200 reads out from the RAM 243 a center side initial setting routine illustrated in FIG. 14 and executes the routine. Meanwhile, the gaming terminal 10 reads out from the RAM 43 a terminal side initial setting routine illustrated in FIG. 14 and executes the routine. The center side and terminal side initial setting routines are executed in parallel.

First, the main CPU 41 of the gaming terminal 10 checks operations of a work memory such as RAM 43 (A1). Then, the main CPU 41 determines if all the check results are normal (A2). If the main CPU 41 determines that the check results contain an error (A2: NO), an error signal is supplied to the center control unit 200 (A3). Further, the error is notified in the form of illuminating the lamp 30 or the like (A4), and then the routine is ended.

On the other hand, if the main CPU 41 determines that the check results are all normal (A2:YES), the main CPU 41 checks operations of various sensors (A5). Then, the main CPU 41 determines if all the check results are normal (A6). If the main CPU 41 determines the check results contain an error (A6: NO), the main CPU 41 executes A3.

On the other hand in A6, if the main CPU 41 determines that the check results are all normal (A6:YES), the main CPU 41 checks operations of various drive mechanisms (A7). Then, the main CPU 41 determines if all the check results are normal (A8). If the main CPU 41 determines the check results contain an error (A8: NO), the main CPU 241 executes A3.

On the other hand in A8, if the main CPU 41 determines that the check results are all normal (A8: YES), the main CPU 41 checks operations of various illuminations (A9). Then, the main CPU 41 determines if all the check results are normal (A10). If the main CPU 41 determines the check results contain an error (A10: NO), the main CPU 41 executes A3.

After the checking operations through the steps Al to A10 for checking operations of various functions, if the main CPU 41 determines that the check results are all normal (A10: YES), the main CPU 41 outputs an initial setting signal to the center control unit 200 (A11). Then, an initial setting signal is waited from the center control unit 200 (A12, A13: NO).

The main CPU 241 of the center control unit 200 receives signals from each of the terminals 10 (B1). Then, the main CPU 241 determines whether a signal received is an error signal (B2) If the main CPU 241 determines that the signal is an error signal (B2: YES), the main CPU 241 outputs the error signal to a server of a not-illustrated host computer or the like (B3) to report the error (B4), and ends the routine.

On the other hand in B2, if the main CPU 241 determines that the signal is not an error signal (B2:NO), the main CPU 241 determines whether a predetermined time (check time) has elapsed from the time of powering on (B5). If the main CPU 241 determines that the check time has elapsed (B5: YES), B3 is executed. On the other hand, if the main CPU 241 determines that the check time has not yet elapsed (B5:NO), it is determined whether an initial setting signal is received from each of the gaming terminals 10 (B6) If the main CPU 241 determines that an initial setting signal from any one of the gaming terminals 10 is not received (B6: NO), the process returns to B1.

On the other hand, if the main CPU 241 determines that initial setting signals from all the gaming terminals 10 are received (B6: YES), the main CPU 241 checks operations of work memory such as the RAM 243(B7). Then, the main CPU 241 determines whether all the check results are normal (B8). If the main CPU 241 determines the check results contain an error (B8: NO), the main CPU 241 executes B3.

On the other hand, if the main CPU 241 determines that the check results are all normal (B8:YES), the main CPU 241 checks operations of various sensors (B9). Then, the main CPU 241 determines whether all the check results are normal (B10). If the main CPU 241 determines the check results contain an error (B10: NO), the main CPU 241 executes B3.

On the other hand in B10, if the main CPU 241 determines that the check results are all normal (B10:YES), the main CPU 241 checks operations of various drive mechanisms (B11). Then, the main CPU 241 determines whether all the check results are normal (B12). If the main CPU 241 determines the check results contain an error (B12: NO), the main CPU 241 executes B3.

On the other hand in B12, if the main CPU 241 determines that the check results are all normal (B12: YES), the main CPU 241 checks operations of various illuminations (B13). Then, the main CPU 241 determines whether all the check results are normal (B14). If the main CPU 241 determines the check results contain an error (B14: NO), the main CPU 241 executes B3.

After the checking operations through the steps B7 to B14, if the main CPU 241 determines in B14 that all the check results are normal (B14: YES), the main CPU 241 outputs an initial setting signal to all the gaming terminals 10 (B15), and causes the shared display 203 to display a demo-screen (B16). Then, the main CPU 241 ends the routine.

In A12, the main CPU 41 of each of the gaming terminals 10 determines that an initial setting signal is received from the center control unit 200 (A13: YES), and causes the terminal display 101 to display a demo-screen (A14). The main CPU 41 then ends the routine.

[Operation of Gaming Terminal 10: Game Running Process Routine]

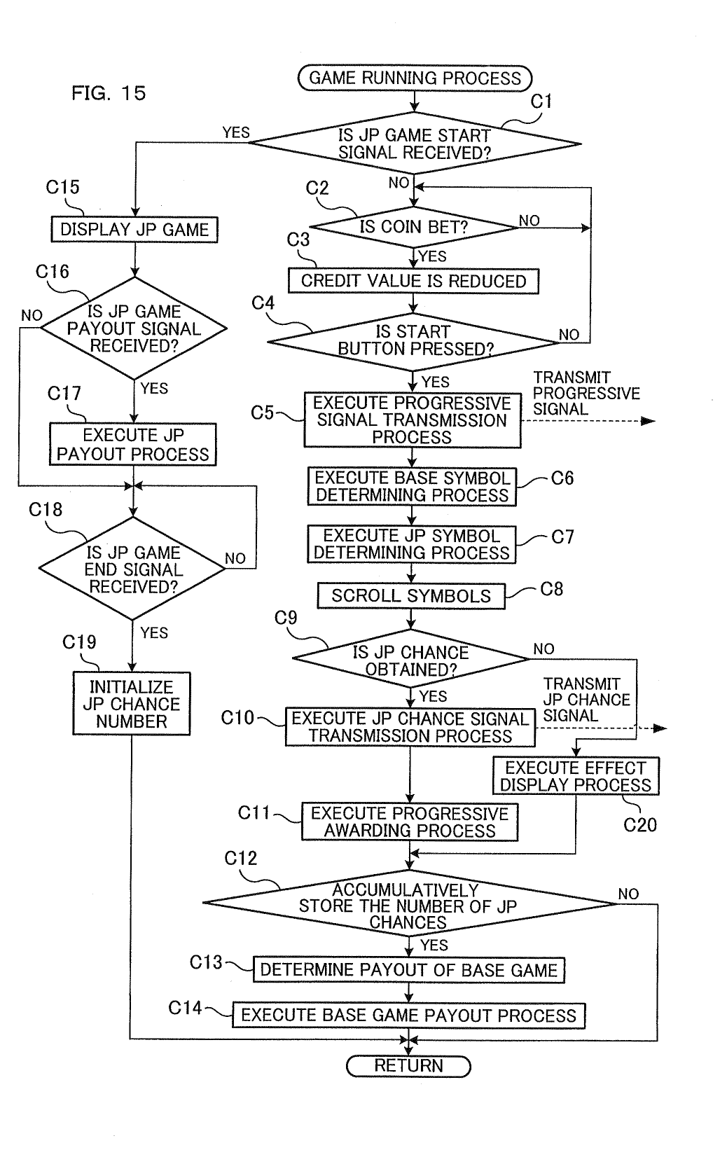

After the terminal side initial setting routine of FIG. 14, the main CPU 41 of the gaming terminal 10 performs a game running process routine of FIG. 15. Through this game running process routine, a game is run.

As illustrated in FIG. 15, in the game running process routine, whether or not a JP game start signal is received from the center control unit 200 is determined (C1). In C1, if it is determined that no JP game start signal is received (C1:NO), whether a coin is bet or not is determined (C2). In this step, it is determined whether a signal from the 1-BET switch 26S entered by pressing of the 1-BET button 26 is received. Meanwhile, it is determined whether a signal from the maximum BET switch 27S entered by pressing of the maximum BET button 27 is received. If no coin is BET (C2: NO), C2 is repeated until a coin is bet.

On the other hand, if a coin is bet (C2: YES), the credit value stored in the RAM 43 is reduced according to the number of coins bet (C3). When the number of coins bet surpasses the credit value stored in the RAM 43, the process goes to a later-detailed step C4 without the reduction of the credit value. When the number of coins bet exceeds the maximum number of coins bettable in one game (50 pieces in this embodiment), the process goes to a later-detailed step C4 without the reduction of the credit value.

Then, it is determined whether a spin button 23 is pressed or not (C4). If the spin button 23 is not pressed (C4: NO), the process returns to C2. Here, if the spin button 23 is not pressed (for example, the spin button 23 is not pressed but a command to end the game is input), the reduction of the credit value in C3 is canceled.

On the other hand, when the spin button 23 is pressed (C4: YES), a progressive transmission process is executed (C5). In other words, a progressive signal indicating a part of the betted progressive value is transmitted to the center control unit 200.

Next executed is a base symbol determining process (C6). That is, the stop symbol determining program stored in the RAM 43 is run to determine base symbols 180 to be stopped in the matrix 156. This determines a combination of base symbols to be stopped in the matrix 156.

Next executed is a JP symbol determining process (C7). That is, the stop symbol determining program stored in the RAM 43 is run to determine base symbols 180J to be stopped in the matrix 156. Through this step is determined a combination of JP symbols to be stopped in the matrix 156.

Then, the scrolling process is executed to scroll base symbols 180 and JP symbols 180J at the same time, on the terminal display 101 (C8). The scrolling process is a process in which the base symbols 180 and the JP symbols 180J respectively determined in C6 and C7 are stopped (rearranged) in the matrix 156 after scrolling of symbols 180 and JP symbols 180J in an upward/downward direction.

Next, there is determined whether JP symbols 180J rearranged in the matrix 156 form a winning combination (C9). If it is determined that a winning combination is not formed (C9:NO), there is determined whether payout is awarded as a result of the base game (C12).

On the other hand in C9, if it is determined that a winning combination is formed (C9: YES), an effect display process is executed (C20) and a JP chance signal is supplied to the center control unit 200 (C10). The effect display process in the step C20 is executed in such a way that effect images shown in FIG. 5 are played back for a predetermined period of time in the effect image display area 16a. After C10, the number of JP chances is added to the number of JP chances in RAM 43 (C11). In this step, the accumulated total of the JP chances is displayed in the JP chance display area 160 of the lower image display panel 16.

Subsequently, if it has been determined in C12 that there is payout as a result of the base game (C12:YES), an amount of payout is determined based on the rearranged base symbols 180 (C13). After the payout is determined, a pay out process is executed (C14). On the other hand in C12, if it is determined that there is no payout as a result of the base game (C12: NO), this routine is ended.

If a JP game start signal is received from the center control unit 200 (C1:YES), effect images related to the JP game are displayed on the lower image display panel 16 (C15).

After the lower image display panel 16 displays thereon the effect images related to the JP game in C15, there is determined whether a JP game payout signal has been received from the center control unit 200 (C16). If it is determined that no JP game payout signal is received (C16:NO), there is determined whether a JP game end signal is received from the center control unit 200 (C18).

On the other hand, if it is determined that a JP game payout signal is received from the center control unit 200 (C16:YES), a payout based on the JP game payout signal is awarded (C17) C18 is executed thereafter.

If it is determined that no JP game end signal is received (C18:NO), a JP game end signal is waited (C18).

On the other hand, if it is determined that a JP game end signal is received from the center control unit 200 (C18:YES), the number of JP chances stored in the RAM 43 is set to an initial value (C19). In this step, the number of JP chances displayed on the JP chance display area 160 of the lower image display panel 16 is also set to the initial value. This routine ends thereafter.

[Operation of Gaming Terminal 10: Effect Skip Process Routine]

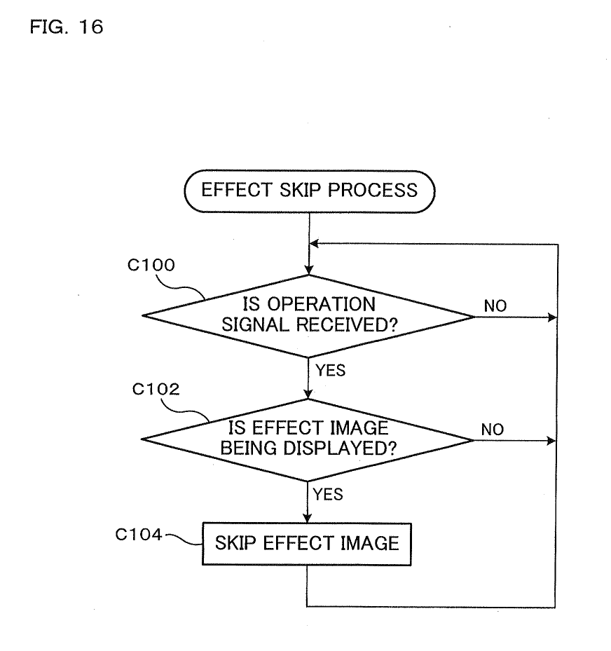

Now, referring to FIG. 16, an effect skip process routine executed in each gaming terminal 10 is discussed. The main CPU 41 of the gaming terminal 10 executes main processes of the effect skip process routine, when the skip button 28 is pressed during the effect display process of the step C20 in the game running process routine shown in FIG. 15, so that an operation signal is supplied.

There is determined first whether the operation signal has been received (C100). To be more specific, there is determined whether the skip button 28 has been pressed and the main CPU 41 has received the operation signal which is output from the skip switch 28S in response to the detection of the pressing. If no operation signal has been received (C100:NO), the process of the step C1 is repeated.

If the operation signal has been received (C100:YES), there is determined whether effect images are being played back (102). To be more specific, there is determined whether effect images 16b and 16c are being played back on the effect image display area 16a of the lower image display panel 16, in the effect display process of the step C20 in the game running process routine illustrated in FIG. 15 (C102).

If the effect images 16b and 16c are not being played back (C102:NO), the processes of the steps C100 to C102 are repeated. If the effect images 16b and 16c are being played back (C102:YES), the effect images are skipped so that they are shortened (C104). To be more specific, an interruption signal is transmitted to the game running process routine so that the display of the effect images is stopped. In response to this, the game running process routine starts the next step. Thereafter the processes of the steps C100 to C104 are repeated.

In this way, a player can shorten effect images displayed on the lower image display panel 16, by means of the skip button 28 which accepts an external input operation. This satisfies the player's desire to play as many games as possible within limited time before the next JP game, thereby reducing the player's stress.

(Operation of Gaming Terminal 10: Count Down Display Process Routine)

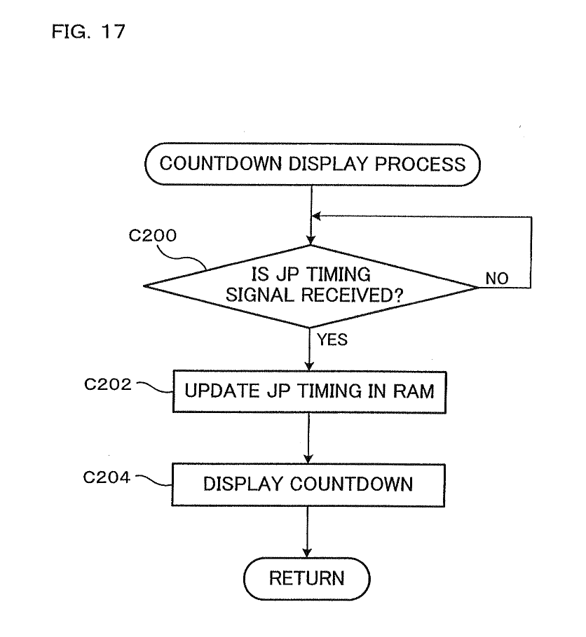

Now, the following describes a count down process routine executed in each gaming terminal 10, with reference to FIG. 17. The main CPU 41 of the gaming terminal 10 executes the count down display process routine concurrently with the game running process routine shown in FIG. 15.

There is determined first whether a JP timing signal has been received (C200). The JP timing signal is transmitted to all gaming terminals 10 which are connected to and in communication with the center control unit 200. If no JP timing signal has been received (C200:NO), the process of C200 is repeated.

On the other hand, if the JP timing signal has been received (C200:YES), JP timing stored in the RAM 43 of the gaming terminal 10 is updated based on the thus received JP timing signal (C202). Based on the updated JP timing in the RAM 43, the countdown of time left until a JP game is displayed as illustrated in FIG. 3 (C204).

As such, a player is able to play a base game and a chance game at the same time while time left until a JP game is run is being counted down on the display, and hence the player is allowed to obtain a JP chance as well as a result of the base game. Consequently the player is allowed to concentrate on getting JP chances until the timing of the next JP game, and this realizes a new entertainment characteristic such that a chance game is playable while a base game is being played.

(Operation of Center Control Unit 200: Progressive Addition Process Routine)

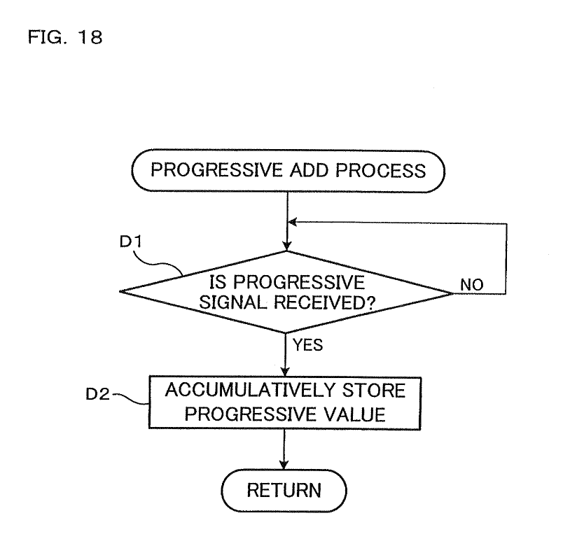

FIG. 18 illustrates a progressive addition process routine executed by the center control unit 200. When the progressive addition process is executed, the main CPU 241 of the center control unit 200 determines whether a progressive signal from a gaming terminal 10 is received (D1). If the center control unit 200 determines that no progressive signal is received (D1:NO), the center control unit 200 waits for a progressive signal (D1).

On the other hand, if the center control unit 200 determines that a progressive signal is received from a gaming terminal 10 (D1:YES), the center control unit 200 accumulatively stores a progressive value indicated by the progressive signal in the RAM 243 (D2). This routine ends thereafter.

(Operation of Center Control Unit 200: JP Chance Addition Process Routine)

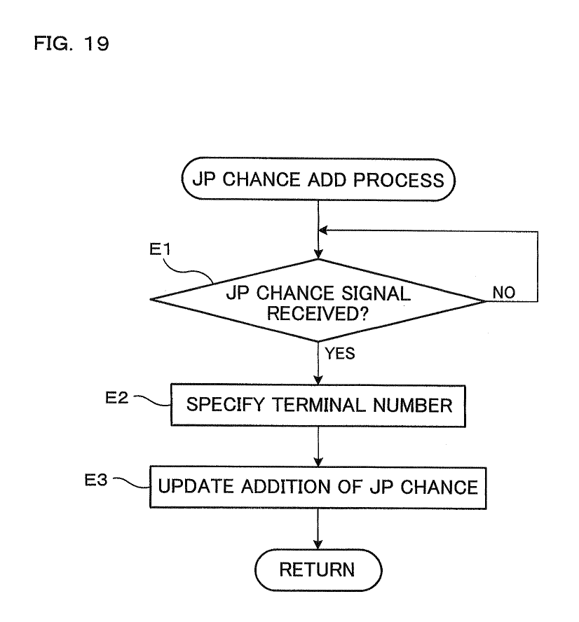

FIG. 19 illustrates a JP chance addition process routine executed by the center control unit 200. When the JP chance addition process routine is executed, the main CPU 241 of the center control unit 200 determines whether a JP chance signal is received from a gaming terminal 10 (E1). If the center control unit 200 determines that no JP chance signal is received (E1: NO), the center control unit 200 waits for the JP chance signal (E1).

On the other hand, if it is determined in E1 that a JP chance signal has been received from a gaming terminal 10 (El:YES), the gaming terminal ID of the gaming terminal 10 which has transmitted the signal is specified with reference to the JP chance signal (E2). Then, the “game terminal ID” specified in E2 is associated with the “number of JP chances” which is based on the JP chance signal, and the associated sets of data are stored and updated in the JP chance data table of the RAM 243 (E3). This routine ends thereafter.

[Operation of Center Control Unit 200: JP Game Running Process Routine]

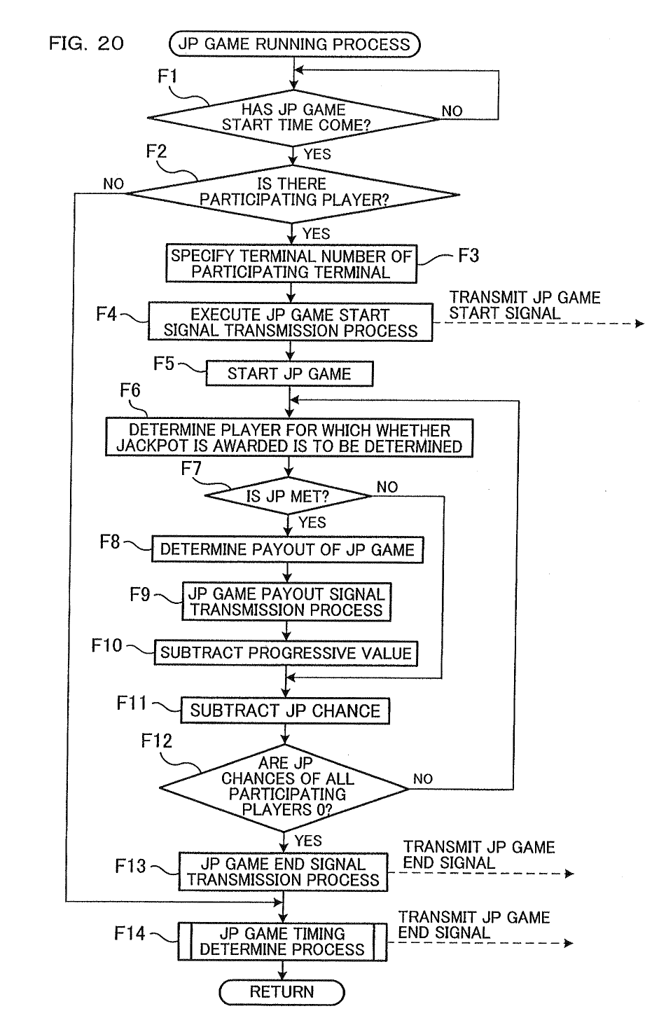

FIG. 20 is a diagram illustrating a JP game running process routine executed by the center control unit 200. When the JP game running process routine is executed, the center control unit 200 determines whether a JP game starting time has come (F1). If the center control unit 200 determines the JP game starting time has not come (F1:NO), the JP game starting time is waited (F1).

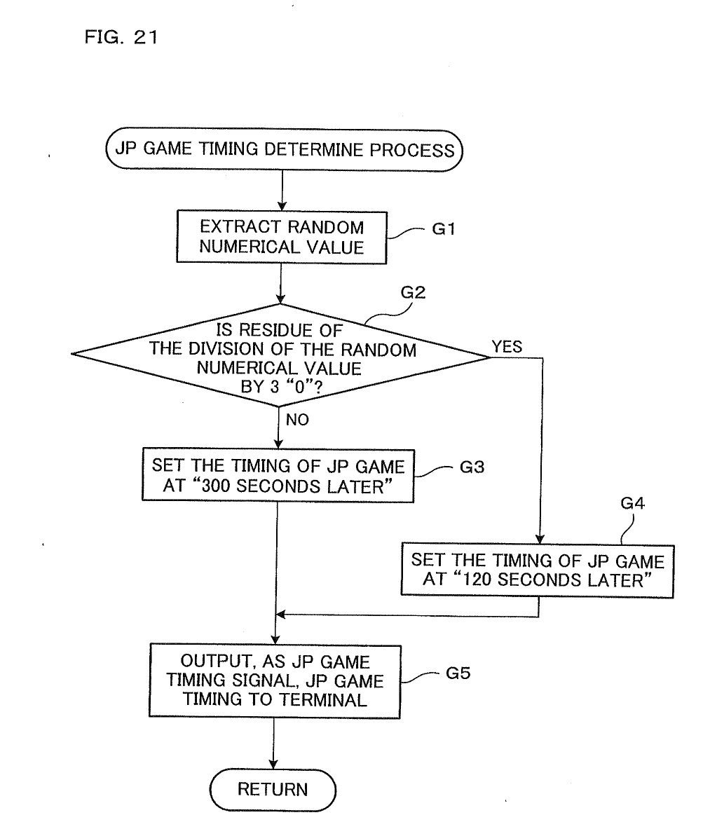

On the other hand in F1, if the center control unit 200 determines the JP game starting time has come (F1:YES), the center control unit 200 determines if there is a gaming terminal 10 to participate in the JP game, by referring to the JP chance data table stored in RAM 243 (F2). If it is determined that no gaming terminal 10 participates (F2:NO), the JP game timing determine process is executed (F14) and the routine is ended. The JP game timing determine process will be detailed later with reference to FIG. 21.

On the other hand in F2, if there is a gaming terminal 10 to participate in the JP game (F2:YES), the center control unit 200 specifies the gaming terminal ID of that gaming terminal 10 (F3). Thereafter, a JP game start signal is transmitted to the gaming terminal 10 corresponding to the gaming terminal ID specified in F4 (F4). This transmission of the JP game start signal in F5 triggers the JP game to start (F5).

When the JP game starts in F5, there is determined a gaming terminal 10 to be subjected to a process of determining whether or not a jackpot is awarded (F6). Then, a process of determining whether or not a jackpot is awarded is performed with respect to a gaming terminal 10 with the gaming terminal ID determined in F7 (F7). If it is determined that a jackpot will not be awarded (F7:NO), the number of JP chances obtained by the gaming terminal 10 with the determined gaming terminal ID, which number is stored in the RAM 243, is reduced by “1” (F11).

On the other hand, if in F7 it is determined that a jackpot will be awarded (F7:YES), an amount of the payout of the JP game is determined (F8). After the process of F8, a JP game payout signal is transmitted to the gaming terminal 10 having the thus determined gaming terminal ID (F9). Next, a progressive value corresponding to the amount of the payout of the JP game determined in F8 is subtracted from the accumulated progressive value in the RAM 243 (F10). After F10 is played F11.

After F11, there is determined whether JP chances of all the gaming terminals 10 stored in the RAM 243 are consumed (F12). If it is determined that there is a JP chance yet to be consumed (F12: NO), a gaming terminal 10, for which whether jackpot is awarded is to be determined, is determined again (F6).

On the other hand, if it is determined in F12 that all JP chances are consumed (F12:YES), a JP game end signal is transmitted to the gaming terminal 10 to which the JP game start signal have been transmitted (F13). This routine ends thereafter.

[Operation of Center Control Unit 200: JP Game Timing Determine Process Routine]

FIG. 21 illustrates a JP game timing determine process routine in the center control unit 200. The JP game timing determine process routine is a process which is called in the JP game running process routine. The JP game timing determine process routine randomly determines the timing to run the next JP game.

First, a random numerical value extraction program is read out from the ROM 242, and a random numerical value is extracted from a predetermined range (e.g. 0 to 255) of random numerical values (G1). Then there is determined whether a residue of the division of the extracted random numerical value by 3 is “0” (G2). If the residue is not “0” (G2:NO), the timing to run the next JP game is set at “600 seconds later” (G3). Specifically, the timing of the JP game in the RAM243 is updated to “600 seconds later”. On the other hand, if the residue is “0” (G2:YES), the timing of the next JP game is set at “120 seconds later” (G4). Specifically, the timing of the JP game in the RAM243 is updated to “120 seconds later”. Thereafter, as a JP game timing signal, the timing of the JP game, which has been set in the step G3 or step G4, is transmitted to each gaming terminal 10 (G5), and then the routine is ended.

In this way, the gaming machine 1 is structured so that the timing to run a JP game is randomly determined, and this provides a player with a game with further improved entertainment characteristic.

In the present embodiment the timing of a JP game is determined as above, but the present invention is not limited to this. A JP game may be run at predetermined intervals. Also, the random determination of the timing of a JP game may be performed in a different way. For example, a JP game may be run at intervals of the seconds calculated by multiplying an extracted random numerical value by a predetermined value.

(Alternative Form)

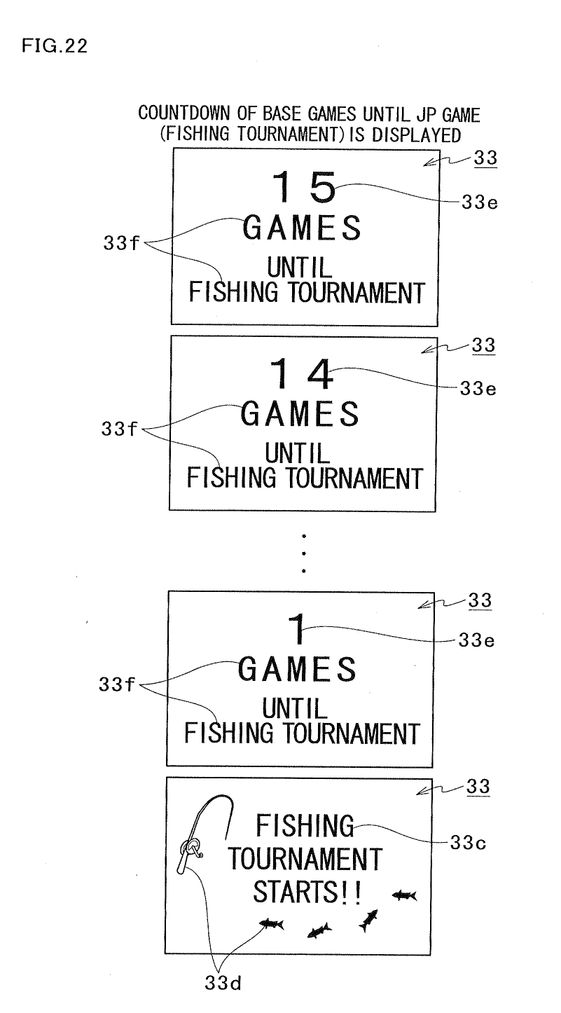

In the present embodiment, the upper image display panel 33 displays the countdown of time left until a JP game is run, as illustrated in FIG. 3. The present invention however is not limited to this. For example, as illustrated in FIG. 22, the upper image display panel 33 may count down the number of playable base games before the timing to run a JP game.

Specifically, until the timing of the next JP game, the upper image display panel 33 displays a count down value image 33e indicating the number of playable base games before the JP game and a first template image 33f which explains the count down value image 33e. For example, as illustrated in the uppermost upper image display panel 33 in FIG. 22, the upper image display panel 33 displays a count down value image 33e showing the number “15” and a first template image 33f which reads “games until Fishing Tournament”, when the number of playable base games before the JP game is 15. Viewing the character string image “15 games until Fishing Tournament” on the count down value image 33e, the player recognizes that a Fishing Tournament which is a JP games starts after playing 15 base games. Furthermore, as illustrated in FIG. 22, the count down value image 33e is updated in accordance with the number of playable base games before a JP game. The player can therefore recognize the timing to start the JP game, at any time.

When a JP game starts, a second template image 33c indicating that the JP game has started and a JP game effect image 33d regarding the JP game are displayed as set forth in the lowest upper image display panel 33 in FIG. 22. Specifically, displayed are a second template image 33c reading “Fishing Tournament starts!!” and a JP game effect image 33d showing a fishing rod and fishes. This allows bystanders or the like of the gameplay to notify that the JP game has started.

As such, a player is able to play a base game and a chance game at the same time, while the number of playable base games before the timing to run a JP game is being displayed on the display, and hence the player is allowed to obtain a JP chance as well as a result of the base game. Consequently the player is allowed to concentrate on getting JP chances during playing of a limited number of base games before the timing of the next bonus game, and this realizes a new entertainment characteristic such that a chance game is playable while a base game is being played.

Note that this embodiment deals with a case where the JP game is run for a gaming terminal 10 having one or more JP chance; however, the present invention is not limited to this. For example, the JP game may be run for a gaming terminal 10 having three or more JP chances.

Further, this embodiment deals with a case where one JP chance is awarded for a winning combination when three JP symbols 180J are successively arranged on a pay line L in the matrix 156; however, the present invention is not limited to this. For example, the scatter symbol method may be adopted so that two JP chances are awarded when three JP symbols 180J are arranged in the matrix 156.

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer or computer network. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes performed in the steps or blocks, these processes are essentially executed by various devices. Further, the other structures necessary for the steps or blocks are obvious from the above descriptions.

What is claimed is:

1. A gaming machine comprising:
a base game offering a chance of winning a payout according to a predetermined combination;
a chance game offering a chance of obtaining a chance flag which qualifies a player to join a bonus game offering a chance of winning a higher payout than the base game;
a display displaying information which is based on a timing to run the bonus game;
a storage unit storing the number of chance flags; and
a controller which is programmed to perform the steps of:
(a1) displaying on the display the information based on the timing to run the bonus game;
(a2) running the base game and the chance game at the same time;
(a3) determining and awarding a payout according to a result of the base game;
(a4) determining the number of chance flags according to a result of the chance game, and awarding a resulting number of chance flags;
(a5) accumulatively storing in the storage unit the number of chance flags awarded; and
(a6) awarding a payout determined according to a result of the bonus game which is run when the number of the chance flags stored in the storage unit equals or surpasses a predetermined number.

2. A gaming machine according to claim 1,
wherein, the controller randomly determines the timing to run the bonus game.

3. A gaming machine comprising:
a base game offering a chance of winning a payout according to a predetermined combination;
a chance game offering a chance of obtaining a chance flag which qualifies a player to join a special game offering a chance of winning a higher payout than the base game;
a display displaying information which is based on a timing to run the bonus game;
a storage unit storing the number of chance flags; and
a controller which is programmed to perform the steps of:
(b1) displaying on the display the number of the base game before the timing to run the bonus game;
(b2) running the base game and the chance game at the same time;
(b3) determining and awarding a payout according to a result of the base game;
(b4) determining the number of chance flags according to a result of the chance game, and awarding a resulting number of chance flags;
(b5) accumulatively storing in the storage unit the number of chance flags awarded; and
(b6) awarding a payout determined according to a result of the bonus game which is run when the number of the chance flags stored in the storage unit equals or surpasses a predetermined number.

4. A gaming machine comprising:
a base game offering a chance of winning a payout according to a predetermined combination;
a chance game offering a chance of obtaining a chance flag which qualifies a player to join a bonus game offering a chance of winning a higher payout than the base game;
a display displaying information which is based on a timing to run the bonus game;
a storage unit storing the number of chance flags; and
a controller which is programmed to perform the steps of:
(c1) on the display, counting down time left until the timing to run the bonus game;
(c2) running the base game and the chance game at the same time;
(c3) determining and awarding a payout according to a result of the base game;
(c4) determining the number of chance flags according to a result of the chance game, and awarding a resulting number of chance flags;
(c5) accumulatively storing in the storage unit the number of chance flags awarded; and
(c6) awarding a payout determined according to a result of the bonus game which is run when the number of the chance flags stored in the storage unit equals or surpasses a predetermined number.

5. A gaming machine, comprising:
a base game offering a chance of winning a payout according to a predetermined combination;
a chance game offering a chance of obtaining a chance flag which qualifies a player to join a bonus game offering a chance of winning a higher payout than the base game;
a display displaying information which is based on a timing to run the bonus game;
a storage unit storing the number of chance flags;
an effect producing device which produces an effect for the base game and/or the chance game;
an operation device which accepts an external input operation and outputs an input signal; and
a controller which is programmed to perform the steps of:
(d1) on the display, counting down time left until the timing to run the bonus game;
(d2) running the base game and the chance game at the same time;
(d3) determining and awarding a payout according to a result of the base game;
(d4) determining the number of chance flags according to a result of the chance game, and awarding a resulting number of chance flags;
(d5) accumulatively storing in the storage unit the number of chance flags awarded;
(d6) awarding a payout determined according to a result of the bonus game which is run when the number of the chance flags stored in the storage unit equals or surpasses a predetermined number;
(d7) causing the effect producing device to produce an effect for the base game and/or the chance game;
(d8) determining whether the input signal has been output from the operation device; and
(d9) if the input signal has been output, shortening the effect produced by the effect producing device.

6. A playing method of a gaming machine which includes: a base game offering a chance of winning a payout according to a predetermined combination;
a chance game offering a chance of obtaining a chance flag which qualifies a player to join a bonus game offering a chance of winning a higher payout than the base game;
a display displaying information which is based on a timing to run the bonus game; and
a storage unit storing the number of chance flags, the method comprising the steps of:
(e1) displaying on the display the number of the base game before the timing to run the bonus game;
(e2) running the base game and the chance game at the same time;
(e3) determining and awarding a payout according to a result of the base game;
(e4) determining the number of chance flags according to a result of the chance game, and awarding a resulting number of chance flags;
(e5) accumulatively storing in the storage unit the number of chance flags awarded; and
(e6) awarding a payout determined according to a result of the bonus game which is run when the number of the chance flags stored in the storage unit equals or surpasses a predetermined number.
